(19) United States
(12) Patent Application Publication
(10) Pub. No.: US 2025/0105373 A1
(43) Pub. Date: Mar. 27, 2025

(54) Reduced Graphene Oxide Interlayered LLTZO Laminated Solid-State Electrolyte for Arresting Lithium Dendrite Growth

(71) Applicant: Brown University, Providence, RI (US)

(72) Inventors: Brian W. Sheldon, Brookline, MA (US); Zikang Yu, Providence, RI (US); Changmin Shi, Providence, RI (US)

(21) Appl. No.: 18/899,107

(22) Filed: Sep. 27, 2024

Related U.S. Application Data
(60) Provisional application No. 63/540,753, filed on Sep. 27, 2023.

(51) Int. Cl. H01M 10/42; H01M 10/0525; H01M 10/0562

(52) U.S. Cl. CPC H01M 10/4235; H01M 10/0562; H01M 10/0525; H01M 2300/0071

(57) ABSTRACT

The present disclosure describes a method of inhibiting lithium dendrite penetration through a lithium-based solid electrolyte by providing the lithium-based solid electrolyte with an interlayer of reduced Graphene Oxide. The present disclosure also describes a lithium-based solid electrolyte with an interlayer of reduced Graphene Oxide.

### FEDERALLY SPONSORED RESEARCH AND DEVELOPMENT

This invention was made with government support under grant number DMR-2124775 awarded by the National Science Foundation. The government has certain rights in the invention.

### TECHNICAL FIELD

The present disclosure relates to lithium-based solid-state electrolytes for use in solid state lithium metal anode batteries, and to solid-state lithium metal anode batteries including such lithium-based solid-state electrolytes.

### DESCRIPTION OF RELATED ART

All-solid-state lithium metal batteries (ASSLBs) using solid electrolytes (SEs) such as LLZTO (Li_{6.4}La₃Zr_{1.7}Ta_{0.3}O₁₂) have the potential to allow mass commercialization of electric vehicles and electric storage systems for smart grids given their high energy density (˜900 Wh/L) and improved safety, especially when combined with a lithium metal anode, which have the highest theoretical capacity (3860 mAh/g) among anode materials (Krauskopf, T., Richter, F. H., Zeier, W. G. & Janek, J. Physicochemical concepts of the lithium metal anode in solid-state batteries, Chem. Rev., 120, 7745-7794 (2020); Manthiram, A., Yu, X. & Wang S., Lithium battery chemistries enabled by solid-state electrolytes Nat. Rev. Mater., 2, 1-16 (2017); Zhao, Q., Stalin, S., Zhao, C.-Z. & Archer, L. A., Designing solid-state electrolytes for safe, energy-dense batteries, Nat. Rev. Mater., 5, 229-252 (2020); Famprikis, T., Canepa, P., Dawson, J. A., Islam, M. S. & Masquelier, C., Fundamentals of inorganic solid-state electrolytes for batteries, Nat. Mater., 18, 1278-1291 (2019)). Inorganic garnet-structure oxide solid-state electrolytes such as Li_{6.4}La₃Zr_{1.7}Ta_{0.3}O₁₂ (LLTZO) have been popular due to their relatively high ionic conductivity at room temperature (˜0.1-1 mS·cm⁻¹ at 25° C.) and a wide electrochemical stability window (Murugan, R., Thangadurai, V. & Weppner, W., Fast lithium ion conduction in garnet-type Li₇La₃Zr₂O₁₂, Angew. Chem. Int. Ed., 46, 7778-7781 (2007); Zhao, N. et al., Solid garnet batteries, Joule 3, 1190-1199 (2019); Jalem, R. et al., Concerted migration mechanism in the Li ion dynamics of garnet-type Li₇La₃Zr₂O₁₂, Chem. Mater., 25, 425-430 (2013); Samson, A. J., Hofstetter, K., Bag, S. & Thangadurai, V., A bird's-eye view of Li-stuffed garnet-type Li₇La₃Zr₂O₁₂ ceramic electrolytes for advanced all-solid-state Li batteries, Energy Environ. Sci., 12, 2957-2975 (2019); Miara, L. J., Richards, W. D., Wang, Y. E. & Ceder, G., First-principles studies on cation dopants and electrolyte cathode interphases for lithium garnets, Chem. Mater., 27, 4040 4047 (2015); Meier, K., Laino, T. & Curioni, A. Solid-state electrolytes: revealing the mechanisms of Li-ion conduction in tetragonal and cubic LLTZO by first-principles calculations, J. Phys. Chem. C., 118, 6668-6679 (2014)). One major practical limitation of LLTZO has been the tendency of lithium dendrite growth, i.e., the formation of lithium filaments or “dendrites”, through the electrolyte, which causes short circuiting, uncontrolled discharge, and thermal runaway (Albertus, P., et al., Challenges for and Pathways toward Li-Metal Based All-Solid-State Batteries, Acs Energy Letters, 2021, 6(4): p. 1399-1404; Krauskopf, T., Mogwitz, B., Rosenbach, C., Zeier, W. G. & Janek, J., Diffusion limitation of lithium metal and Li—Mg alloy anodes on LLTZO type solid electrolytes as a function of temperature and pressure, Adv. Energy Mater., 9, 1902568 (2019); Krauskopf, T. et al., The fast charge transfer kinetics of the lithium metal anode on the garnet-type solid electrolyte Li_{6.25}Al_{0.25}La₃Zr₂O₁₂, Adv. Energy Mater., 10, 2000945 (2020); Kasemchainan, J. et al., Critical stripping current leads to dendrite formation on plating in lithium anode solid electrolyte cells, Nat. Mater., 18, 1105-1111 (2019); Ning, Z. et al., Visualizing plating-induced cracking in lithium-anode solid-electrolyte cells. Nat. Mater., 20, 1121-1129 (2021); Ping, W. et al., Reversible short-circuit behaviors in garnet-based solid-state batteries, Adv. Energy Mater. 10, 2000702 (2020). A multitude of recent studies have proposed that dendrite propagation in LLZTO occurs via a fracture-like mechanism, with the dendrite behaving like an internally loaded Griffith crack (Porz, L., et al., Mechanism of Lithium Metal Penetration through Inorganic Solid Electrolytes, Advanced Energy Materials, 2017, 7 (20); Yuan, C. H., W. Q. Lu, and J. Xu, Unlocking the Electrochemical-Mechanical Coupling Behaviors of Dendrite Growth and Crack Propagation in All-Solid-State Batteries, Advanced Energy Materials, 2021, 11(36); Klinsmann, M., et al., Dendritic cracking in solid electrolytes driven by lithium insertion, Journal of Power Sources, 2019, 442; Cao, D. X., et al., Lithium Dendrite in All-Solid-State Batteries: Growth Mechanisms, Suppression Strategies, and Characterizations, Matter, 2020. 3(1): p. 57-94; Wang, W., et al., Modeling of Void-Mediated Cracking and Lithium Penetration in All-Solid-State Batteries, Advanced Functional Materials, 2023; Yuan, C. H., et al., Coupled crack propagation and dendrite growth in solid electrolyte of all-solid-state battery, Nano Energy, 2021, 86; Fincher, C. D., et al., Controlling dendrite propagation in solid-state batteries with engineered stress, Joule, 2022, 6(12): p. 2794-2809; Kalnaus, S., et al., Solid-state batteries: The critical role of mechanics, Science, 2023, 381(6664): p. 1300-+). In this process, as the lithium-filled crack extends forward, the internal pressure is alleviated, but the continual flux of lithium into the dendrite repressures the filament and leads to additional crack extension. This continuous process results in dendrite propagation through the LLZTO driven primarily by internal stresses. Several recent publications have proposed dendrite propagation mitigation strategies that are based on their stress-driven nature (Athanasiou, C. E., et al., High-Toughness Inorganic Solid Electrolytes via the Use of Reduced Graphene Oxide, Matter, 2020, 3(1): p. 212-229; Qi, Y., C. M. Ban, and S. J. Harris, A New General Paradigm for Understanding and Preventing Li Metal Penetration through Solid Electrolytes, Joule, 2020, 4(12): p. 2599-2608). For example, Fincher et al. have directly shown that applied stresses can deflect dendrites in LLZTO. Classic Monroe-Newman theory suggests that the mechanical rigidness and high shear moduli of inorganic solid-state electrolytes, such as LLTZO, would almost completely suppress dendrite growth (Monroe, C. & Newman, J., The impact of elastic deformation on deposition kinetics at lithium/polymer interfaces, J. Electrochem. Soc., 152, A396 (2005); Charles Monroe and John Newman, Dendrite Growth in Lithium/Polymer Systems: A Propagation Model for Liquid Electrolytes under Galvanostatic Conditions, Journal of The Electrochemical Society, 2003, Volume 150, Number 10), but recent evidence has suggested that dendrite growth and propagation can occur in inorganic ceramic solid state electrolytes such as LLTZO at even low current densities of 0.05-0.3 mA·cm⁻² (Han, F. et al., High electronic conductivity as the origin of lithium dendrite formation within solid electrolytes, Nat. Energy, 4, 187-196 (2019); Lu, Y. et al., An in situ element permeation constructed high endurance Li-LLZO interface at high current densities, J. Mater. Chem., A6, 18853-18858 (2018); Fu, K. K. et al., Toward garnet electrolyte-based Li metal batteries: an ultrathin, highly effective, artificial solid-state electrolyte/metallic Li interface, Sci. Adv., 3, e1601659 (2017)). Surface defects on LLTZO such as voids and pores, as well as the electronic conductivity of LLTZO (˜10⁻⁸ S·cm⁻¹), induce Li nucleation and subsequent lithium dendrite growth along grain boundaries and pores.

The general strategy of lithium dendrite deflection at an interlayer interface is inspired by laminated ceramic structures, where crack deflection can substantially increase the overall fracture resistance of the material (He, M. Y. and J. W. Hutchinson, CRACK DEFLECTION AT AN INTERFACE BETWEEN DISSIMILAR ELASTIC-MATERIALS, International Journal of Solids and Structures, 1989, 25(9): p. 1053-1067; Cheng, L., et al., Structure design, fabrication, properties of laminated ceramics: A review. International Journal of Lightweight Materials and Manufacture, 2018, 1(3): p. 126-141; Zhang, K., et al., Design of crack deflection induced high toughness laminated Si₃N₄ ceramics based on hollow oriented one-dimension, Ceramics International, Volume 48, Issue 15, 2022, Pages 21370-21377). Specifically, this behavior is enabled when a crack running through a composite ceramic material, upon reaching a bi-material interface, deflects and runs parallel along the interfacial layer for a substantial period instead of directly fracturing through the composite. This phenomenon can dramatically increase damage tolerance and delay the complete through-thickness fracture of the material. This suggests that it should be possible to similarly deflect pressure-driven lithium dendrites at bi-material interfaces in composite solid electrolytes. The critical Current Density (CCD) is the maximum current density a cell can endure during cycling without short circuiting due to lithium dendrite penetration across the solid electrolyte and is directly related to power density. Thus, the CCD measurement is commonly used as a benchmark for the dendrite-resisting properties of electrolytes. CCD values of 3 mA·cm⁻² and above are exemplary for implementing commercial high-energy systems, as defined by the recent Department of Energy (DOE) ARPA-E IONICS program goal (available at the website of The Advanced Research Projects Agency-Energy (ARPA-E)).

Multiple approaches have been attempted to prevent dendrite propagation through solid-state electrolytes and improve the Critical Current Density, including chemical treatment and acid etching to remove native layers from the solid-state electrolyte for an impurity-free surface, depositing metallic thin films such as Ag on the SE/Li metal interface to increase wettability and interfacial contact, introducing an artificial interphase layer to suppress void formation, or applying high hydrostatic stack pressure during cycling (Xu, H. et al., Li₃N-modified garnet electrolyte for all-solid-state lithium metal batteries operated at 40° C., Nano Lett., 18, 7414-7418 (2018); Kim, S. et al., The role of interlayer chemistry in Li-metal growth through a garnet-type solid electrolyte, Adv. Energy Mater., 10, 1903993 (2020); Chen, Y. et al., Nanocomposite intermediate layers formed by conversion reaction of SnO₂ for Li/garnet/Li cycle stability, J. Power Sources, 420, 15-21 (2019); Shi, K. et al., In situ construction of an ultra-stable conductive composite interface for high-voltage all-solid-state lithium metal batteries, Angew. Chem., Int. Ed. 59, 11784-11788 (2020); Huo, H. et al., A flexible electron-blocking interfacial shield for dendrite-free solid lithium metal batteries, Nat. Commun., 12, 176 (2021); Direct correlation between void formation and lithium dendrite growth in solid-state electrolytes with interlayers; Xu, H. et al., Li₃N-modified garnet electrolyte for all-solid-state lithium metal batteries operated at 40° C., Nano Lett., 18, 7414-7418 (2018)). These approaches, however, typically require complicated and expensive steps, toxic chemical treatment, high stack pressures of 10-40 MPa, or high cycling temperatures of up to 60° C., (Manalastas, W. et al., Mechanical failure of garnet electrolytes during Li electrodeposition observed by in-operando microscopy, J. Power Sources. 412, 287-293 (2019); 27.22; Porz, L. et al. Mechanism of lithium metal penetration through inorganic solid electrolytes, Adv. Energy Mater 7, 1701003 (2017); Krauskopf, T., Hartmann, H., Zeier, W. G. & Janek, J., Toward a fundamental understanding of the lithium metal anode in solid-state batteries—an electrochemo-mechanical study on the garnet-type solid electrolyte Li_{6.25}Al0_{.25} La₃Zr₂O₁₂, ACS Appl. Mater. Interfaces, 11, 14463-14477 (2019); Wang, M. J., Choudhury, R. & Sakamoto, J., Characterizing the Li-solid-electrolyte interface dynamics as a function of stack pressure and current density, Joule, 3, 2165-2178 (2019); Lu, Y. et al., An in situ element permeation constructed high endurance Li-LLZO interface at high current densities, J. Mater. Chem., A 6, 18853-18858 (2018)) and fail to reach the 3 mA·cm⁻² threshold exemplary for commercial energy systems. Accordingly, methods and solid-state electrolyte structures are needed to improve Critical Current Density and inhibit dendrite formation.

### SUMMARY OF THE INVENTION

Aspects of the present disclosure are directed to a method of suppressing crack growth in lithium-based solid-state electrolytes to inhibit lithium filament penetration. Aspects are also directed to solid state electrolytes according to the present disclosure which exhibit exemplary CCD and inhibited lithium dendrite formation.

According to one aspect, an engineered laminated electrolyte having an interlayer is disclosed where dendrite penetration is contained within the interlayer. According to one aspect, a thin layer of reduced Graphene Oxide (rGO) as a 3D hierarchical porous interlayer is embedded between two LLTZO garnet electrolyte discs to create a laminated architecture. According to the present disclosure, rGO is a flexible porous carbon matrix and a mixed ion-electron conductor, and “absorbs” both lithium ions and electrons, and itself acts as a high specific surface-area support and stable scaffold for lithium (Guangjian Hu et al., 3D Graphene-Foam-Reduced-Graphene-Oxide Hybrid Nested Hierarchical Networks for High-Performance Li—S Batteries, Advanced Materials, Volume 28, Issue 8, 2016, pages 1603-1609; Asad Ali, et al., The role of graphene in rechargeable lithium batteries: Synthesis, functionalization, and perspectives, Nano Materials Science, 2022). According to the present disclosure, a lithium dendrite, upon contact with the rGO, plates within the interlayer instead of continuing penetration through the LLTZO electrolyte, as seen in FIG. 2G. Without the engineered rGO interlayer, the critical current density for plating-only cycles of a control sample is measured to be only 0.55 mA·cm⁻², but this CCD value increases up to 7 times to 3.8 mA·cm⁻² upon introduction of this rGO interlayer, indicating that the laminated structure is effective in suppressing dendrite penetration until much higher current densities.

As a multitude of fracture mechanics and chemo-mechanical processes are at play in this dendrite deflection phenomenon, the present disclosure provides a comprehensive electro-chemo-mechanical model to interpret this form of deflection behavior in laminated structures. To generalize this work for broader application cases, the present disclosure provides a Finite Element Model that shows various laminated electrolyte structures and their abilities in dendrite suppression. Accordingly, a solid-state electrolyte architecture design having a reduced Graphene Oxide (rGO) interlayer within or inside of a lithium-based solid electrolyte, such as Tantalum-doped LLTZO (Li_{6.4}La₃Zr_{1.7}Ta_{0.3}O₁₂), is disclosed herein which inhibits or arrests or contains lithium dendrite penetration, leading to higher CCD than without the reduced Graphene Oxide interlayer.

According to one aspect, a method is provided to inhibit or limit or arrest or contain lithium dendrite penetration or filament growth of lithium within a lithium-based solid-state electrolyte by providing the lithium-based solid-state electrolyte with a reduced Graphene Oxide (rGO) interlayer within or inside of a lithium-based solid electrolyte. The reduced Graphene Oxide layer inhibits lithium dendrite formation or penetration past the reduced Graphene Oxide layer under certain critical current densities. According to one aspect, the resulting lithium-based solid-state electrolyte has an increased CCD compared to a lithium-based solid-state electrolyte without the intermediate reduced Graphene Oxide (rGO) interlayer.

### BRIEF DESCRIPTION OF DRAWINGS

The patent or application file contains at least one drawing executed in color. Copies of this patent or patent application publication with color drawing(s) will be provided by the Office upon request and payment of the necessary fee. The foregoing and other features and advantages of the present embodiments will be more fully understood from the following detailed description of illustrative embodiments taken in conjunction with the accompanying drawings in which:

FIGS. 1A-1C depict models of dendrite penetration and deflection at interlayers within solid electrolyte. FIG. 1A depicts lithium dendrite penetrating through a solid electrolyte (LLZTO) before reaching the engineered interlayer. Lithium flux is concentrated at the dendrite tip. FIG. 1B depicts a theoretically valid but realistically unlikely complete dendrite arrest mechanism at the composite material interface between the LLZTO and the engineered interlayer. FIG. 1C depicts Li dendrite penetration and deflection at an engineered interlayer.

FIGS. 2A-2G depict schematics and SEM images of engineered interlayer-electrolyte structures. FIG. 2A depicts a PEO-LLZTO cell: Thin 1 um PEO interlayer intercalated between two pieces of LLZTO. FIG. 2B depicts an rGO-LLZTO cell: Thin 1 um rGO interlayer intercalated between two pieces of LLZTO. FIG. 2C depict an in-LLZTO cell: Physical Vapor Deposition of ˜2.5 um thin Indium metallic layer bonded between two pieces of LLZTO. FIG. 2D depicts a c-LLZTO cell: Thin (<1 um) liquid LiTFSI electrolyte layer intercalated between two pieces of LLZTO. FIG. 2E depicts an SEM cross section image of rGO-LLZTO. FIG. 2F depicts a plane view of rGO interlayer. FIG. 2G is an SEM cross-section image of i-LLTZO (zoomed in).

FIGS. 3A-3D are directed to experimental analysis. FIG. 3A depicts current density and cell voltage versus time of plating only cycles of i-LLTZO with zoomed in section of the 87^{th}-93^{rd} hours. FIG. 3B depicts current density and cell voltage versus time of P-LLTZO plating only cycles. FIG. 3C depicts current density and cell voltage versus time of c-LLTZO plating only cycles. FIG. 3D depicts voltage versus time of Long-term cycling data of i-LLTZO and c-LTLZO at 0.5 mA·cm⁻².

FIGS. 4A-4E depict the electrochemical performance of different electrolytes. FIG. 4A depicts c-LLZTO electrochemical plating response. A total short circuit occurs at 0.6 mA·cm⁻², with no evidence of a partial short and recovery. FIG. 4B depicts the PEO-LLZTO electrochemical plating response. Cell experiences a small overpotential drop at 0.85 mA·cm⁻², indicative of small amount of lithium dendrite deflection on the PEO interlayer. The cell eventually shorts at 1.05 mA·cm⁻². FIG. 4C depicts an rGO-LLZTO electrochemical plating response (left); zoomed-in section of the final 70th-76th hours (right). The solid electrolyte with the rGO interlayer exhibits a much higher current density of 3.8 mA·cm⁻² at which point a potentiostat voltage cutoff stopped the test. The EIS spectra collected (shown in the SI) indicate that the cell is shorted due to dendrite penetration. FIG. 4D depicts an in-LLZTO electrochemical plating response. A total short circuit occurs at 0.6 mA·cm⁻² with no evidence of partial short and recovery. FIG. 4E depicts a summary of the cell configurations tested in this work, with the average CCD's and average total capacity of lithium run for each engineered configuration. Capacity measurements are based on the lithium current density and plating time. The error bars correspond to the standard deviations for these measurements.

FIGS. 5A-5D depict the results of the experimental analysis. FIG. 5A depicts a three-electrode cell schematic. FIG. 5B depicts a sealed three-electrode cell. FIG. 5C is a graph of rGO lithiation voltage response under constant 0.1 mA·cm⁻² plating current. FIG. 5D is a graph of three-electrode cell voltage OCV and the symmetric cell overpotential overlapped; the OCV (in red) corresponds to the potential difference between the interlayer and the bottom counter electrode and the Cell Overpotential (in black) corresponds to the voltage difference between the top working electrode and bottom counter electrode.

FIGS. 6A-6G depict various aspects of the present disclosure. FIG. 6A depicts a top-down view of rGO layer and planar lithium spread on rGO. FIG. 6B is a top-down SEM image of lithiated rGO. The green circle shows smooth planar metallic lithium deposited on the surface of the rGO interlayer. The red circle depicts lithium firmly intercalated within the rGO hierarchical structure. The blue shows the honeycomb-esque ductile fracture of the lithium dendrite as the two LLTZO pieces are carefully pried apart. FIG. 6C depicts dendrite penetration through top layer of i-LLTZO. FIG. 6D depicts web-like structure of dendritic fracture lines through bottom layer of i-LLTZO. FIG. 6E depicts a cross-sectional SEM image of dendritic fracture line after breaking apart LLTZO. FIG. 6F depicts dendrite penetration through top layer of P-LLTZO. FIG. 6G depicts dendrite penetration through bottom layer of P-LLTZO.

FIGS. 7A-7C are directed to dendrite formation models. FIG. 7A depicts a model that is theoretically valid but realistically unlikely for a complete dendrite arrest mechanism at a laminated composite material interface for an electronically conductive interlayer such as rGO. FIG. 7B depicts crack deflection at the same interface, which is a much more likely process. FIG. 7C depicts crack deflection at a laminated composite material interface for a non-electronically conductive interlayer such as PEO.

FIGS. 8A-8D depict results of FEM modeling that are consistent with the deflection abilities of materials with the same mechanical properties of rGO and LLTZO.

FIGS. 9A-9C depict the expanded electrochemical study of rGO interlayer. FIG. 9A depicts a three-electrode cell OCV and cell overpotential overlapped; the rGO interlayer OCV (in red) corresponds to the potential difference between the rGO interlayer and Li counter electrode; Cell Overpotential (in black) corresponds to the voltage difference between the top working electrode and bottom counter electrode. Three-electrode-cell schematic is shown in the inset. FIG. 9B depicts a 1 μm thin rGO layer lithiation voltage response under constant 0.1 mA·cm⁻² plating current. FIG. 9C depicts long-term cycling comparison of rGO-LLZTO and c-LLZTO at 0.5 mA·cm⁻² symmetric current and 0.5 mAh·cm⁻² capacity limit.

FIGS. 10A-10I depict visual evidence of dendrite deflection/penetration on interlayers after plating-only cycling. FIG. 10A depicts the two LLZTO discs that were carefully pried apart to expose the rGO interlayer. The top-down SEM image shows shiny metallic lithium deflected on the rGO interlayer. FIG. 10B depicts SEM cross-sectional imaging that shows around an 8 um thin layer of lithium scattered on top of the rGO interlayer after deflection. FIG. 10C depicts rGO-LLZTO: Lithium dendrite penetration at the top LLZTO piece after all the lithium and rGO has been polished off. A localized dendrite penetration spot is circled in red. For clarity of location comparison, both LLZTO discs are marked into four quadrants. FIG. 10D depicts rGO-LLZTO: Multiple lithium dendrite penetration lines spread laterally through the bottom LLZTO piece of rGO-LLZTO. FIG. 10E depicts PEO-LLZTO: Lithium dendrite penetration through the top LLZTO piece after a short circuit. The lithium dendrite penetration locale is in the rightmost quadrants. FIG. 10F depicts PEO-LLZTO: Multiple lithium dendrite penetration lines spread laterally through the bottom LLZTO piece of PEO-LLZTO. FIG. 10G depicts the cross-sectional image of “web-like” lithium dendrite after fracturing along a dendritic penetration line in FIG. 10F. FIG. 10H depicts c-LLZTO: Lithium dendrite penetration through the top LLZTO piece after short circuit. The lithium dendrite penetration locale is in the rightmost quadrants. FIG. 10I depicts c-LLZTO: Lithium dendrite penetration through the bottom LLZTO piece after a short circuit. The lithium dendrite penetration locale is also in the rightmost quadrants.

FIGS. 11A-11B depict lithium dendrite deflection at a mixed ionic-electronic conducting interlayer such as rGO. FIG. 11A depicts a schematic of dendritic deflection within the rGO interlayer. Metallic lithium is shown in blue, penetrating through a (transparent) LLZTO disc and deflecting in various directions upon reaching the rGO interlayer, shown in black. FIG. 11B depicts mixed modes of both Li dendrite deflection and Li intercalation into a mixed ionic electronic conductor such as rGO.

FIGS. 12A-12E depict lithium metal dendrite mitigation with multilayer structure. FIG. 12A depicts three models each showing a two-dimensional cross-section of the LLZTO material with length L=10 mm and thickness T=100 μm and different interlayers. A centered seam-like crack (of length 1 and zero thickness) is built in models A-C. The blue arrows show the applied pressure at the dendritic crack surface. Model A shows rGO-LLZTO with a 10 μm thin rGO interlayer. A deflection event (of length r) in Model B is conducted. The “Magnified Deflection” schematic shows the deflecting corner. Different normal plane directions, as shown in (i)-(iii), are implemented for the anisotropic material properties of graphite and rGO. i) The light blue cube represents isotropic LLZTO. ii) layered dark gray hexagons with arrows in the Y direction represent anisotropic rGO whose normal plane is parallel to the interfacial plane. iii) layered dark gray hexagons with arrows in the Z direction represent anisotropic rGO whose normal plane is perpendicular to the interfacial plane. A right-hand coordinate system was employed to delineate directions within interlayers due to rGO's unidirectional anisotropy. FIG. 12B depicts the σxx stress fields (log scale) before (top) and after deflection (bottom) are shown: the symmetric tensile stress distribution at the dendrite tip changes to a compressive/tensile mixed stress state at the rGO interlayer interface. FIG. 12C depicts σxx stress fields (log scale), before the crack reaches the interlayer for two scenarios in FIG. 9C are shown: three 3.33 μm interlayers (top) and ten 1 μm thick interlayers (bottom). FIG. 12D depicts a graph of normalized energy release rate (G/(P*l)) at the crack tip for different interlayer materials. Substantial reductions in the energy release rate relative to isotropic LLZTO are observed with ten interlayers of rGO or graphite 1 (21% and 29%, respectively). FIG. 12E depicts a schematic showing dendrite deflection in multi-layered solid electrolyte structures (top) vs single-phase solid electrolyte (bottom). The multilayered structure greatly increases the “damage” tolerance of the solid electrolyte in terms of lithium dendrite penetration.

### DETAILED DESCRIPTION

Solid-state lithium metal batteries using garnet solid electrolytes such as LLZTO (Li_{6.4}La₃Zr_{1.7}Ta_{0.3}O₁₂) promise substantial improvements in energy density and safety. However, practical implementation is hindered by lithium dendrite penetration at high current densities. Recent work shows that internal pressure in lithium dendrites leads to mechanical stresses that are large enough to fracture solid electrolytes. Building on this understanding, the present disclosure describes that stress-driven dendrite propagation can be controlled via deflection at weakly bonded internal interfaces. This approach, based on a fracture-mechanics analysis of multilayered composites, was investigated with a variety of interlayer materials that were embedded into LLZTO. The viability and effectiveness of dendrite deflection were most clearly evident with reduced graphene oxide where the critical current density increased from 0.6 to 3.8 mA·cm⁻². In this material, both the weak interface with LLZTO and the mixed ionic-electronic conducting nature of the interlayer contribute to improved performance. Additional insight into the mechanics of multilayered electrolytes was also obtained with finite element modeling. The overall results present a promising proof-of-concept demonstration along with important generalized design guidelines for creating multilayered solid electrolyte architectures that can enable high-performance solid-state batteries.

In one embodiment, the present disclosure demonstrates that a fracture-mechanics framework accurately describes lithium dendrite deflection at an interlayer. The idea of dendrite deflection due to an elastic mismatch was proposed in a previous modeling study, without considering the role of interfacial debonding energies (Yuan, C. H., B. W. Sheldon, and J. Xu, Heterogeneous Reinforcements to Mitigate Li Penetration through Solid Electrolytes in All-Solid-State Batteries, Advanced Energy Materials, 2022, 12(39)). Experimental evidence of dendrite redirection at interfaces has been presented in several studies that use sulfide electrolytes (Ye, L. and X. Li, A dynamic stability design strategy for lithium metal solid state batteries, Nature, 2021, 593 (7858): p. 218-222; Hu, B., et al., Deflecting lithium dendritic cracks in multi-layered solid electrolytes, Joule, 2024). However, the contact with Li causes these SE materials to decompose, which makes it difficult (and arguably impossible) to interpret the impact that stresses have on dendrite propagation and deflection at an internal interface. The stability of LLZTO with Li makes it a logical choice for investigating dendrite deflection. This was investigated by testing a variety of interlayers with vastly different properties. While a number of prior studies have examined LLZTO in multilayer structures, these generally employ coating layers between the lithium anode and solid electrolyte, or use stacked heterogeneous electrolytes which do not provide direct information about dendrite deflection (Kim, J. S., et al., Surface engineering of inorganic solid-state electrolytes via interlayers strategy for developing long-cycling quasi-all-solid-state lithium batteries, Nature Communications, 2023, 14(1); Lee, K., et al., Multifunctional Interface for High-Rate and Long-Durable Garnet-Type Solid Electrolyte in Lithium Metal Batteries, ACS Energy Letters, 2022, 7(1): p. 381-389; Zhu, F. J., et al., In-situ construction of multifunctional interlayer enabled dendrite-free garnet-based solid-state batteries, Nano Energy, 2023, 111; Wang, Z., et al., A novel asymmetrical multilayered composite electrolyte for high performance ambient-temperature all-solid-state lithium batteries, Journal of Materials Chemistry A, 2024, 12(7): p. 4231-4239; Zhu, X. Q., et al., Strategies to Boost Ionic Conductivity and Interface Compatibility of Inorganic-Organic Solid Composite Electrolytes, Energy Storage Materials, 2021, 36: p. 291-308; Shin, H. S., et al., Multilayered, Bipolar, All-Solid-State Battery Enabled by a Perovskite-Based Biphasic Solid Electrolyte, Chemsuschem, 2018, 11(18): p. 3184-3190).

Of the materials that was investigated in this study, the most effective was reduced graphene oxide (rGO), where mechanical and electrochemical effects appear to provide important synergistic benefits. By increasing the tortuosity of the dendritic path, dendritic deflection at these interlayers increases the work of fracture and substantially delays catastrophic lithium dendrite penetration and cell failure. Both analytical modeling and a finite element model (FEM) were used to elucidate the fracture-mechanics conditions for lithium dendrite deflection at these interlayers.

The present disclosure is directed to a lithium-based solid-state electrolyte having a reduced Graphene Oxide (rGO) interlayer within the reduced Graphene Oxide (rGO) interlayer. The present disclosure is also directed to a method of making a lithium-based solid-state electrolyte by including a reduced Graphene Oxide (rGO) interlayer within the reduced Graphene Oxide (rGO) interlayer. The present disclosure is also directed to a method of inhibiting or limiting or arresting or containing lithium dendrite penetration or filament growth of lithium within a lithium-based solid-state electrolyte by providing the lithium-based solid-state electrolyte with a reduced Graphene Oxide (rGO) interlayer within or inside of a lithium-based solid electrolyte. According to one aspect, the resulting lithium-based solid-state electrolyte has an increased CCD compared to a lithium-based solid-state electrolyte without the intermediate reduced Graphene Oxide (rGO) interlayer.

According to one aspect, the present disclosure provides a composite laminated solid-state electrolyte architecture that is resilient against dendrite penetration. By embedding an electronically conductive 2D material in the form of reduced Graphene Oxide between two layers of LLTZO ceramic electrolyte, dendrite propagation through the composite electrolyte can inhibited by guiding lithium dendrite growth along and into the rGO interlayer instead of transversely and penetrating through the electrolyte. An exemplary LLTZO symmetric cell having an rGO interlayer has high critical current densities of ˜3.8 mA·cm⁻² during plating-only cycles, up to 7 times higher than the control cell without an rGO interlayer. A chemo-electro-mechanical analysis of the results observed is provided, along with FEM simulations showing potential real-world solid electrolyte architecture using the laminated design. This composite electrolyte architecture can significantly delay cell shortage and enable solid-state batteries to be cycled at much higher current densities without significant concern of uncontrolled discharge.

### Example I

### Mechanics of Dendrite Propagation and Deflection

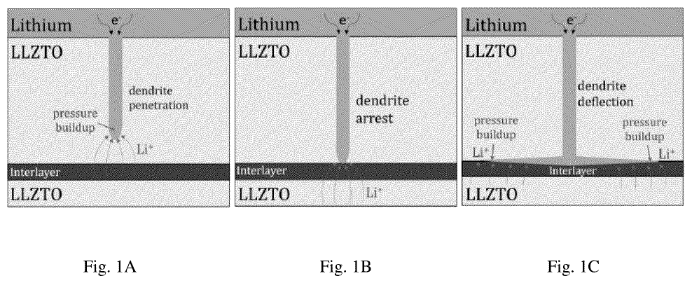

Solid electrolyte fracture (and subsequent cell failure) is thermodynamically favorable when the elastic strain energy released due to dendrite extension (G) reaches the fracture resistance of the material. Several ways introducing a bi-material interface can mitigate this process. Specifically, three different scenarios are assessed: (1) complete crack arrest, (2) crack penetration into the second material, and (3) crack deflection along the interface. The application of these ideas to a solid electrolyte with a general interlayer material is shown in FIGS. 1A-1C.

Continuous Lithium flux into a lithium-filled dendrite will produce internal pressure that applies stress normal to the dendrite/solid electrolyte interface, σₓₓ^{flaw} (y). For a plane strain configuration (i.e., an infinitely thick SE slab), the Mode I stress intensity factor (SIF) for this internal loading is given by (He, M. Y. and J. W. Hutchinson, CRACK DEFLECTION AT AN INTERFACE BETWEEN DISSIMILAR ELASTIC-MATERIALS, International Journal of Solids and Structures, 1989. 25(9): p. 1053-1067; Hutchinson, J. W. and Z. Suo, Mixed Mode Cracking in Layered Materials, in Advances in Applied Mechanics, J. W. Hutchinson and T. Y. Wu, Editors. 1991, Elsevier, p. 63-191; Rahman, M. K., M. M. Hossain, and S. S. Rahman, An analytical method for mixed mode propagation of pressurized fractures in remotely compressed rocks, International Journal of Fracture, 2000. 103(3): p. 243-258.):

$${K}_{I}^{f} = ψ \sqrt{π c} {\overline{p}}_{eff} \qquad ( 1 )$$

where c is the flaw/crack length and:

$${\overline{p}}_{eff} = \frac{2}{π} {\int }_{0}^{c} \frac{{σ}_{xx}^{flaw} ( y )}{\sqrt{{c}^{2} - {y}^{2}}} d y \qquad ( 2 )$$

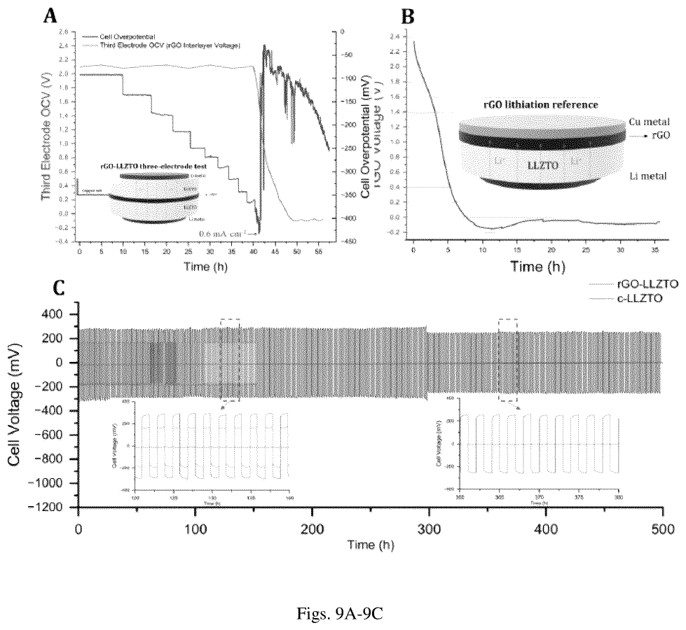

The right side of this expression accounts for variations in the internal pressure along the length of the dendrite (which may occur due to dynamic effects). The factor ψ depends on the crack geometry: the planar edge crack in our case (FIG. 9A) gives a ψ≅1.12. The corresponding strain energy release rate due to dendrite propagation is then given by:

$$G = \frac{{K}_{I}^{2}}{{E}_{SE}^{′}} \qquad ( 3 )$$

where E′_{SE} is the plane strain modulus of the electrolyte. Fracture is expected when G exceeds the fracture resistance of the electrolyte (R_{S}). This condition is generally defined by the critical SIF, K_{Ic}:

$${K}_{I}^{f} > {K}_{Ic} \qquad ( 4 )$$

where R_{S}=K_{Ic}²/E′_{SE}. With a fixed value of p_{eff}⁻ and a strongly bonded interface, fracture stops if the second material has a fracture resistance, R_{L}, that is larger than that of the SE, and crack penetration into the second material occurs if R_{L}≤R_{S}. If the crack arrest condition is met, it is often temporary, since the continuing lithium flux into a static lithium filament increases the pressure (i.e., a larger p_{eff}⁻ will increase K_{I}^{f}). However, fracture through this second material will be halted if the pressure completely counteracts the electrochemical driving force (i.e., p=F η_{P}/Vₘ, where p is the hydrostatic pressure in the dendrite, F is the Faraday constant, np is the local overpotential, and Vₘ is the Li molar volume (Porz, L., et al., Mechanism of Lithium Metal Penetration through Inorganic Solid Electrolytes, Advanced Energy Materials, 2017. 7(20); Athanasiou, C. E., et al., High-Toughness Inorganic Solid Electrolytes via the Use of Reduced Graphene Oxide, Matter, 2020. 3(1): p. 212-229). This thermodynamically defined limiting value is determined by the local overpotential (which can vary along the length of the dendrite). If this value exceeds the fracture threshold, then additional lithium flux into the dendrite should ultimately lead to continued propagation, rather than arrest. With a weakly bonded interface, crack deflection occurs instead (see FIG. 1B). The energetics for this were analyzed by He and Hutchinson and others (He, M. Y. and J. W. Hutchinson, CRACK DEFLECTION AT AN INTERFACE BETWEEN DISSIMILAR ELASTIC-MATERIALS, International Journal of Solids and Structures, 1989. 25(9): p. 1053-1067; Ahn, B. K., et al., Criteria for crack deflection/penetration criteria for fiber-reinforced ceramic matrix composites, Composites Science and Technology, 1998. 58(11): p. 1775-1784). For materials with the same elastic modulus, the resulting criteria for deflection is:

$${Γ}_{D} / {R}_{L} < ∼ 1 / 4 \qquad ( 5 )$$

where Γ_{D} is the fracture resistance for the deflected (interface) crack. This interfacial property is a measure of the adhesion between the two materials (i.e., measured with the peel test described below), in contrast to R_{L} which is a bulk property (described above). It is proposed that a similar energy-based analysis applies to the propagation of a pressurized lithium dendrite, and that deflection at weak interfaces is advantageous for designing interlayers that will mitigate dendrite penetration.

After initial dendrite deflection occurs, its continuing propagation should differ from a deflected crack in several important ways. The pressure build-up inside of the deflected dendrite will create an elastic driving force that favors propagation along the interface. Thus, the stress-field at the crack tip will initially include contributions from the pressure in both the interlaminar and the pre-deflection filaments (FIG. 1C). The latter will dissipate as the tip moves further along the interface, and thus the stress field will approach pure Mode I loading (due to the internal pressure) after the deflected crack has run far enough. This differs from the conventional fracture case with external loading, where the deflected crack is subjected to a different combination of Mode I/Mode II contributions.

### Example II

### Method of Making a Lithium-Based Solid Electrolyte with a Reduced Graphene Oxide Interlayer

LLTZO pellets (600 um thick, Toshima) as purchased were heat treated at 500° C. for 4 hours and polished on P800 and P1200 grit sandpaper for 15 min to remove contaminants from the surface. rGO powder (Graphnea) and PVDF-HFP binder (Sigma-Aldrich) were dried in vacuum furnace at 60° C. for 48 hours. rGO powder was added to PVDF binder (5:1 weight ratio) in an acetone solution with a 0.6M LiTFSI 0.4M LiNO3 DOL/DME (1:1 volume ratio) liquid electrolyte (PVDF: electrolyte 15:1 molar ratio) and mixed thoroughly.

A polypropylene tip was used to carefully create a polypropylene seal on the outer edge of the LLTZO pellet on a hot plate to minimize solution leakage onto the sides to the LLTZO. A volumetric pipette was used to carefully drop-cast the rGO solution onto the surface of the LLTZO. A second LLTZO piece was placed on top of the drop cast rGO layer to complete the i-LLTZO electrolyte having an interlayer of rGO between a first or upper LLTZO solid state electrolyte material electrolyte and second or lower LLTZO solid state electrolyte material. This setup was placed on a hot plate at 60° C. in the glovebox for adhesion and further drying.

P-LLTZO (an LLTZO electrolyte having a PEO interlayer between a first or upper LLTZO solid state electrolyte material electrolyte and second or lower LLTZO solid state electrolyte material) was created similarly. 1,000,000 MW (nominal) PEO powder was mixed thoroughly in an acetonitrile solution for 12 hours. This solution was drop-cast onto the LLTZO surface as with the i-LLTZO cell to create the PEO interlayer. Likewise, PVDF-LLTZO was created by adding PVDF powder to acetonitrile and mixing thoroughly to create a PVDF solution, then drop-casting this solution onto LLTZO to create the PVDF interlayer. C-LLTZO was created by simply dripping 0.6M LiTFSI 0.4M LiNO3 DOL/DME (1:1 volume ratio) liquid electrolyte into the interlayer.

### Example III

### Preparation of a Coin Cell

The i-LLTZO electrolyte was placed onto a Celgard 2325 polypropylene separator with liquid electrolyte solution. Lithium metal (˜200 um) was cleaned to remove carbonates and other contaminants from the surface. Lithium metal electrodes with a diameter of 6.5 mm were punched from the lithium metal and placed on both sides of the solid-state electrolyte (SSE) to create a Li∥Li symmetric coin cell. In order to improve interfacial contact between the lithium electrode and oxide surface, a few drops of 0.6M LiTFSI 0.4M LiNO3 DOL/DME (1:1 volume ratio) liquid electrolyte was dropped onto this interface. The coin cell was then pressed at a pressure of 250 MPa using a cold-isostatic press to seal the coin cell. All cells were assembled in CR2032 type coin cells in an Argon glovebox to minimize exposure to oxygen and moisture. Three-electrode coin cells were made by inserting a copper tab with copper exposed on the ends and insulated with Kapton tape in the center into the rGO interlayer. After crimping the coin cell with the copper tab extending out, epoxy was used to seal the edges of the coin cell in the vicinity to the copper tab to prevent electrolyte leakage and ensure a full seal.

### Example IV

### Electrochemical Measurements

All electrochemical measurements were made after resting the cell for 2 hrs. Potentiostatic electrochemical impedance spectroscopy (PEIS) measurements were conducted on a Biologic SP300 at 25° C. with an open circuit in the potentiostatic mode over a frequency range from 0.1 Hz to 10 kHz using AC perturbation of 10 mV with a frequency response analyze. A battery cycler (Biologic, SP300) was employed to measure the voltage curves of the cells at 25° C. under plating only sequences. The sequences were designed to begin plating at a current density of 0.1 mA/cm² with a 1 mAh/cm² capacity cut-off and with a ramp up step of 0.05 mA/cm². For EIS measurements, the spectra were collected over a frequency range of 100 kHz to 10 mHz with ten points per decade with a perturbation amplitude of 10 mV.

### Example V

### Characterization of Electrolytes Having an Interlayer Laminated Electrolyte Architectures

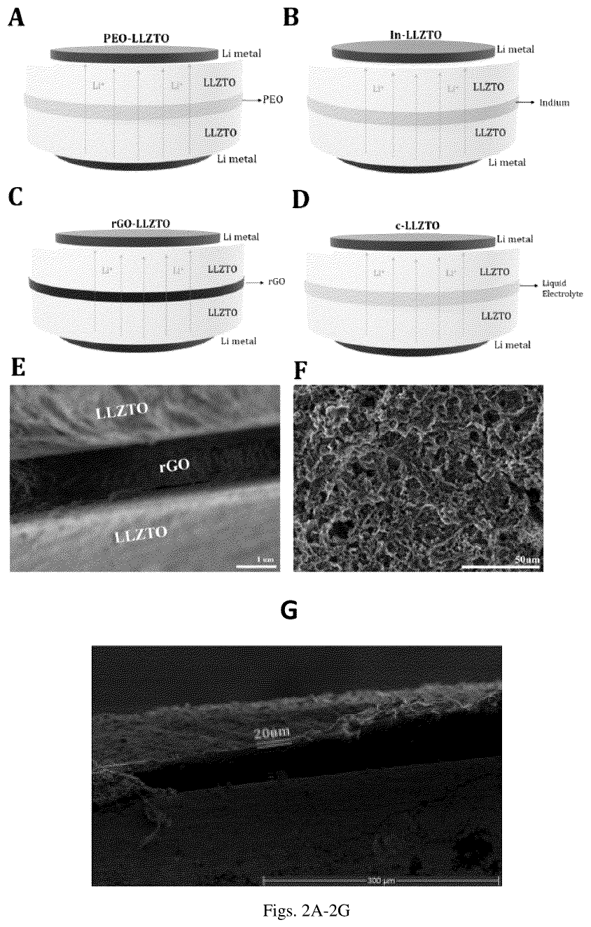

Experiments were designed to investigate dendrite propagation and deflection at an engineered interlayer. To accomplish this, a variety of interlayers with drastically different material properties were constructed between two LLZTO discs. Four of these configurations are depicted in FIG. 2, and an expanded list is given in Table 1. These materials were selected to provide significant variations in three key properties: (1) the elastic modulus, (2) the interfacial fracture resistance, and (3) electronic conductivity (all materials are ionically conductive). Polyethylene Oxide (PEO) was first selected as a solid polymer electrolyte interlayer (labeled PEO-LLZTO in FIG. 2A). Polymer electrolytes (such as PEO) have been explored more broadly to accommodate volume changes during electrochemical cycling (Gupta, A. and J. Sakamoto, Controlling Ionic Transport through the PEOLiTFSI/LLZTO Interface, Electrochemical Society Interface, 2019. 28(2): p. 63-69; Xu, H. S., et al., Safe solid-state PEO/TPU/LLZO nano network polymer composite gel electrolyte for solid-state lithium batteries, Colloids and Surfaces a-Physicochemical and Engineering Aspects, 2022, 653; Li, Z., et al., Ionic Conduction in Composite Polymer Electrolytes: Case of PEO: Ga-LLZO Composites, Acs Applied Materials & Interfaces, 2019, 11(1): p. 784-791; He, W., et al., Three-dimensional LLZO/PVDF-HFP fiber network-enhanced ultrathin composite solid electrolyte membrane for dendrite-free solid-state lithium metal batteries, Journal of Membrane Science, 2023, 665; Shi, C. M., et al., 3D Asymmetric Bilayer Garnet-Hybridized High-Energy-Density Lithium-Sulfur Batteries, Acs Applied Materials & Interfaces, 2022; Chen, F., et al., Improved ionic conductivity and Li dendrite suppression of PVDF based solid electrolyte membrane by LLZO incorporation and mechanical reinforcement, Ionics, 2021, 27(3): p. 1101-1111). Thus, PEO provides a simple basis for considering deflection based on elastic energies. Indium, as a metallic interlayer, was used to test the effects of a both highly ionically and electronically conductive interlayer.

Indium also alloys readily upon contact with Li. The Indium-interlayer electrolyte is shown schematically in FIG. 2B (In-LLZTO). Reduced graphene oxide (rGO) was most explored as a novel interlayer material with high fracture toughness (Ye, S. B., B. Chen, and J. C. Feng, Fracture Mechanism and Toughness Optimization of Macroscopic Thick Graphene Oxide Film, Scientific Reports, 2015, 5) and limited electronic conductivity. To create this engineered interlayer, graphene oxide was synthesized using a modified Hummer's method and harvested into an aqueous GO ink for coating. The GO ink was then pipetted onto one LLZTO disc before capping the sandwich structure with a second LLZTO disc, and then thermally reduced to rGO. The electrolyte with the rGO interlayer is shown in FIG. 2C, labeled rGO-LLZTO. FIG. 2E and FIG. 2F show SEM morphology images of the rGO film. Finally, FIG. 2D shows the design for a control experiment with no engineered interlayer, in which only a thin liquid electrolyte film was inserted between two LLZTO discs (c-LLZTO) for improved contact and cell cycling feasibility. In this configuration, stress generated by the dendrite in the upper layer will not be transferred to the lower layer. In this case, dendrite deflection due to mechanical effects is not expected to occur.

FIG. 2A shows a schematic of an electrolyte as described herein having an interlayer (“i-LLTZO”, such as a 20 μm thick rGO interlayer. To create this engineered interlayer, rGO flakes are suspended into an acetone slurry with trace amounts of PVDF-HFP polymer. PVDF-HFP was chosen as the binder due to its porous structure that can effectively support rGO flakes upon the drying of the acetone. Furthermore, the La atoms in the LLTZO can complex with the C═O groups in the acetone solution, and this complex leads to partial dehydrochlorination of PVDF and increases bonding between the PVDF|rGO and LLTZO discs (Aryanfar, A., et al., Dynamics of Lithium Dendrite Growth and Inhibition: Pulse Charging Experiments and Monte Carlo Calculations, Journal of Physical Chemistry Letters, 2014, 5(10): p. 1721-1726). The resulting engineered interlayer is a ˜20 μm thick wrinkled stack, shown in FIG. 2E and FIG. 2G. The top-down SEM image in FIG. 2F shows the wrinkled rGO structure, full of micro-pores formed by gas evolution when the acetone is rapidly evaporated. This 3D porous rGO hierarchical structure offers a conductive network that facilitates fast ion and electron transport, readily absorbing lithium into the active carbon matrix, and can also accommodate the volumetric expansion upon lithium intercalation and plating.

FIGS. 2B-2D depict three control cells as references for i-LLTZO. FIG. 2B depicts an interlayer of liquid electrolyte (a LiTFSI solution) to mitigate interfacial impedance between two LLTZO discs (hereafter denoted as c-LLTZO). FIG. 2 C depicts an interlayer of Polyethylene Oxide (˜30 um, hereafter denoted as P-LLTZO) and FIG. 2D depicts an interlayer of a 20 um thin layer of rGO coated on a 30 um layer of Polyethylene Oxide (hereafter denoted as i-P-LLTZO).

TABLE 1
Descriptions of Major Cell Configurations tested in this work.

| Cell Name | Configuration Description |
|---|---|
| PEO-LLZTO | 1 μm thin PEO polymer interlayer laminated |
| | between two 500 μm thin LLZTO solid |
| | electrolytes |
| In-LLZTO | 2.5 μm thin Indium interlayer laminated |
| | between |
| | two 500 μm LLZTO solid electrolytes using |
| | physical vapor deposition |
| rGO-LLZTO | 1 μm thin rGO interlayer laminated between |
| | two 500 μm LLZTO solid electrolytes |
| c-LLZTO | Thin liquid LiTFSI electrolyte film drop cast |
| | between |
| | two 500 μm LLZTO solid electrolytes |
| PVDF- | 1 μm thin PVdF polymer interlayer laminated |
| LLZTOX | between two 500 μm LLZTO solid |
| | electrolytes |
| rGO-PEO- | 2 μm thin composite interlayer (1u □m rGO |
| LLZTO | interlayer + 1 μm PEO interlayer) laminated |
| | between two 500 μm thin LLZTO solid |
| | electrolytes |

*Data shown in SI

### Example VI

### Electrochemical Results

Typical CCD measurements are made by plating and stripping symmetrically, and slowly ramping up the current density to observe where the cell ultimately fails. According to one aspect, the solid-state electrolyte having the rGO interlayer described herein confines dendrite penetration through one side of the i-LLTZO. According to the present disclosure, dendrite nucleation and growth initiating from the other lithium electrode is to be avoided. As a result, plating-only current sequences were chosen to force dendrite growth from the top lithium electrode downwards, starting from 0.1 mA· cm⁻² and ramping by 0.1 mA·cm⁻² each step with a 1 mAh capacity limit per plating sequence. Symmetric plating/stripping cycles were also performed.

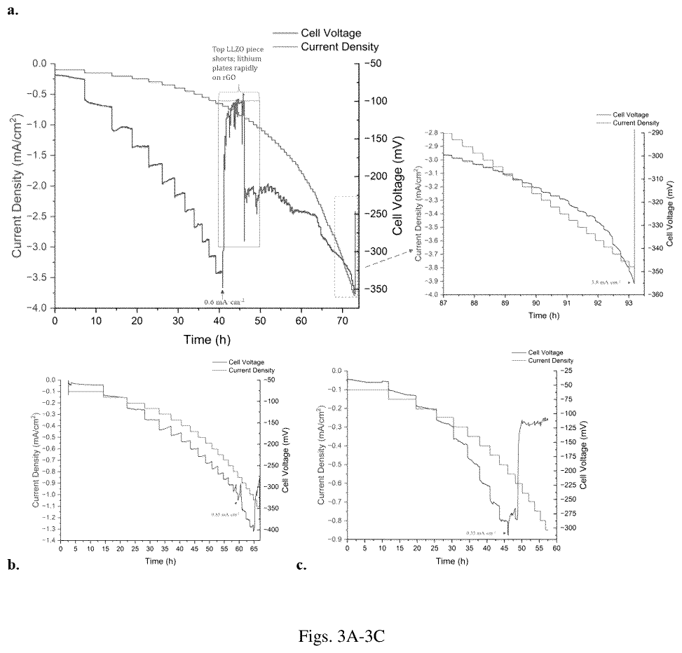

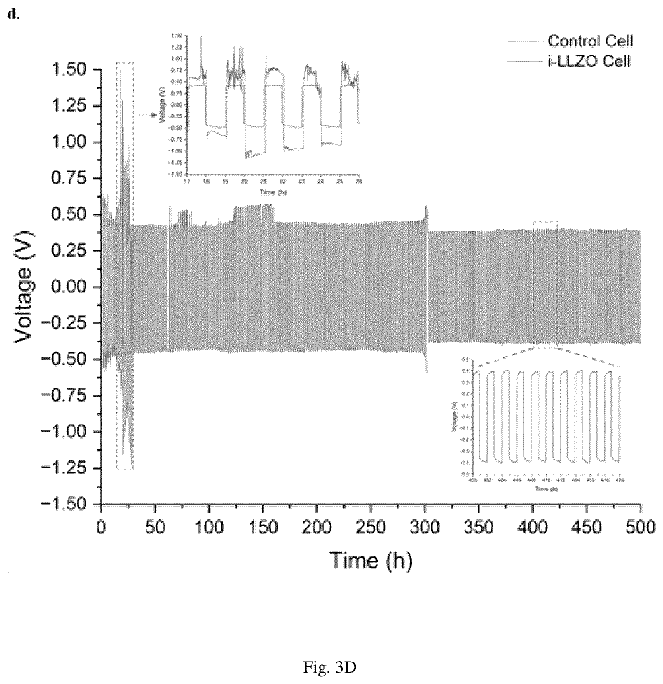

Dendrite deflection at the rGO interface is apparent in the critical current density test. FIG. 3A shows the electrochemical data of the i-LLTZO cell upon plating-only cycles. An overpotential of 80 mV is present during the first plating sequence at 0.1 mA·cm⁻², and due to inhomogeneous lateral expansion of the lithium during the first plating cycle, there is a slight drop in the overpotential profile in this first plating sequence, which quickly recovers as the lithium plating homogenizes on the LLTZO surface. At a current density of 0.6 mA·cm⁻², a unique voltage response occurs in which the overpotential experiences a dramatic decrease to ˜100 mV from ˜350 mV. This voltage drop occurred in all i-LLTZO sample cells built, always occurring around 0.5-0.6 mA·cm⁻², and is representative of a lithium dendrite successfully penetrating through the top LLTZO disc. Upon encountering the rGO interlayer, lithium is rapidly intercalated into the rGO as well as plated on its surface. As the interlayer begins to fill with lithium, this top half of the laminated electrolyte slowly becomes the equivalent of a lithium reservoir.

At around the 67^{th} hour, lithium ceases plating in the rGO interlayer, and the cell continues cycling through the bottom LLTZO disc with an overpotential of 220 mV. The exceptional interfacial bonding between the LLTZO and the 3D porous rGO structure allows for much more uniform and efficient lithium deposition at the LLTZO/rGO surface compared to a bare LLTZO surface. As a result of the improved interfacial bonding of the rGO interlayer and LLTZO, improved wettability that eliminates interfacial void formation and lowers interfacial resistance, and enhanced charge-transfer kinetics, there is much less localization of the current density in the surface defects of the LLTZO. The much more uniform current flow allows the bottom LLTZO piece to cycle at much higher current densities at relatively low overpotentials. At 3.8 mA·cm⁻², the extremely high current density finally forces a lithium dendrite through the bottom LLTZO disc, and the entire cell shorts, as evidenced by the abrupt drop in overpotential at the end of the plating sequence. Symmetric stripping-plating cycles also show up to a 2.55 mA·cm⁻² critical current density, and the realized stable lithium stripping-plating performance for 500 h under a constant 0.5 mA·cm⁻² current density.

To test whether the abilities of the engineered rGO interlayer in trapping dendrite growth are unique, a laminated composite cell with Polyethylene Oxide (PEO) as the interlayer instead of rGO was constructed, as displayed in FIG. 2C. FIG. 3B shows the electrochemical response of the P-LLTZO cell subject to the same plating conditions as i-LLTZO. The cell first experiences a partial short at 0.8 mA·cm⁻², as shown by the small overpotential drop from 330 mV to 300 mV. This small overpotential drop is indicative of lithium being deflected, albeit minimally, on the PEO interlayer, but to a much less extent as with the rGO interlayer: the entire cell cycles to only 1 mA·cm⁻² before shorting completely. A cell with PVDF polymer as the interlayer was also constructed and a similar plating profile was found for this cell. The PEO and PVDF interlayers, unlike the rGO, do not possess porous 3D networks, nor are they mixed ion-electron conductors that can enhance electric fields within themselves.

To monitor dendrite propagation without any interlayer engineering, a control cell, c-LLTZO, was constructed. FIG. 3C shows the electrochemical response of the c-LLTZO electrolyte cell. As there is no interlayer to deflect dendritic penetration, lithium dendrites are in free reign to penetrate through the c-LLTZO electrolyte. The c-LLTZO cell experiences a total short circuit at 0.55 mA·cm⁻², with no evidence of a partial short and recovery, as characteristic of cells with a dendrite-deflecting interlayer. FIG. 3D shows the long-term cycling comparison of i-LLTZO and c-LLTZO. At a constant symmetric plating/stripping current density of 0.5 mA·cm⁻², the voltage curve of the c-LLTZO undergoes severe voltage fluctuations with polarization as high as 2V, indicating rapid dendritic penetration, and shorts at around 50 hours. In contrast, the i-LLTZO shows stable cycling cycles with a much lower polarization voltage of 0.5V, for the entire 500 hours. The i-LLTZO experiences a small overpotential drop from ˜0.49V to ˜0.4V at the 300-hour mark: this is likely representative of dendritic penetration through the top LLTZO disc.

Table 2 below lists a summary of the different relevant cell configurations tested, with the corresponding critical current densities listed. Table 3 compares the i-LLTZO disclosed herein with other recent approaches at addressing lithium dendrite growth and improving CCD. Only CCD values at room temperature are considered in this comparison.

TABLE 2
List of Cell Configurations.

| Cell Configuration Comparison Table | CCD (mA · cm⁻²) |
|---|---|
| i-LLTZO (FIG. 2A) | 3.8 |
| c-LLTZO (FIG. 2B) | 0.55 |
| P-LLTZO (FIG. 2C) | 1.05 |
| i-P-LLTZO (FIG. 2D) | 2.3 |
| Li\|\|LLTZO + PVDF + LLTZO\|\| | 1.05 |
| Celgard Separator\|\|Li | |

TABLE 3
Comparison with Literature.

| Cell Configuration Comparison Table | CCD (mA · cm⁻²) |
|---|---|
| i-LLTZO (described herein) | 3.8 |
| Amorphous aLLTZO-coated cell⁷² | 1.3 |
| 0.15 LiBr-LLTZO⁷³ | 1.0 |
| MgO Densified LLTZO⁷¹ | 0.95 |
| Li—Mg/LiF conductive layer LLTZTO⁷⁰ | 0.65 |
| Sb-coated LLTZO⁷⁴ | 0.64 |

73: Enhanced critical current density of Garnet Li—La Zr₂O₁₂ solid electrolyte by incorporation of LiBr.
72: Blocking lithium dendrite growth in solid-state batteries with an ultrathin amorphous Li—La—Zr—O solid electrolyte.
71: Preparation of dense Ta-LLTZO/MgO composite Li-ion solid electrolyte: Sintering, microstructure, performance and the role of MgO.
70: In-situ construction of Li—Mg/LiF conductive layer to achieve an intimate lithium-garnet interface for all-solid-state Li metal battery.
74: Building a Better Li-Garnet Solid Electrolyte/Metallic Li Interface with Antimony.

Lithium dendrite penetration is typically assessed by measuring critical current density (CCD), which is determined by incrementing the current during symmetric plating-stripping cycles and defining the CCD as the value where the cell fails. However, as this work focuses on exploring the feasibility of dendrite deflection at different interlayers, a unidirectional plating-only electrochemical protocol is primarily used instead. This approach makes it possible to specify the LLZTO layer where lithium dendrite growth initiates (adjacent to the plating Li electrode) and directly observe the electrochemical signal once the lithium dendrite reaches the interlayer. Focusing dendrite propagation on one side of the multilayered electrolyte thus enables a targeted study of dendrite-interlayer interactions that exclude complications introduced during Li stripping. For this unidirectional plating-only procedure, plating was initiated at a 0.1 mA·cm⁻² current density, with increments of 0.05 mA·cm⁻² and a 1 mAh·cm⁻² capacity limit per step. The lithium plating direction (i.e., Li+ ion flux) is represented by light blue arrows in FIGS. 2A-2D with lithium dendrite propagation occurring downwards in all scenarios.

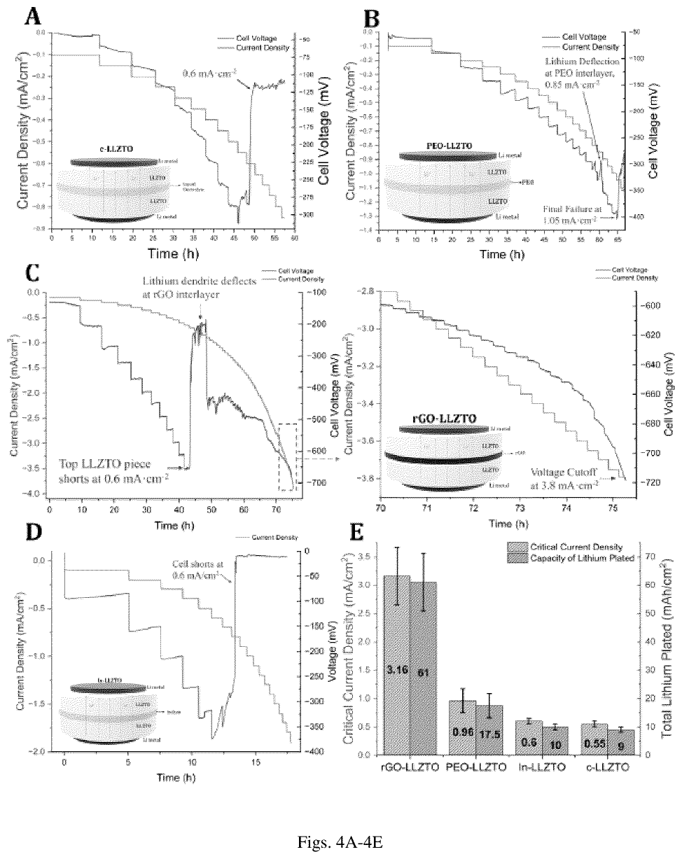

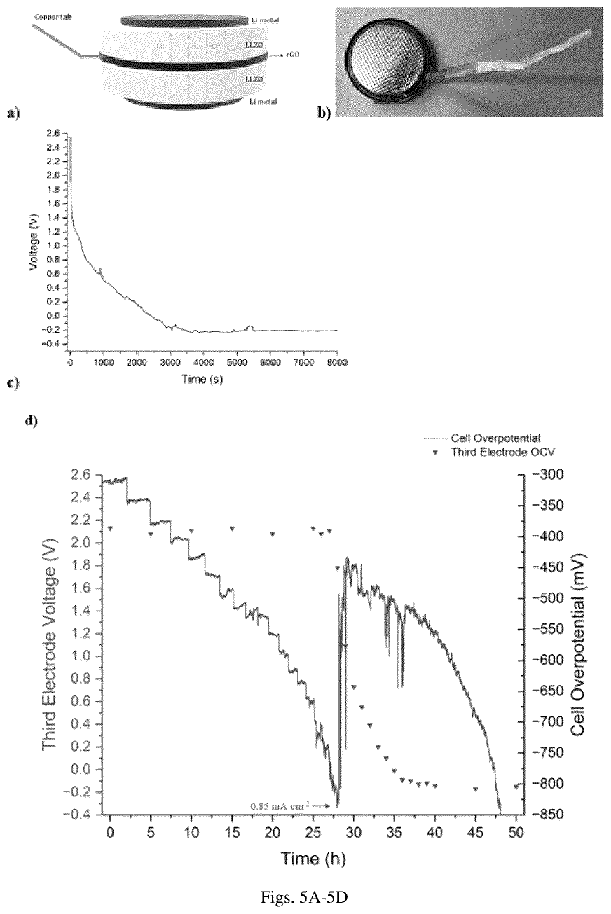

The c-LLZTO control cells provide a basis for comparing solid electrolytes with different engineered interlayers. FIG. 4A shows data for a typical control cell, without any engineered interlayer, in which cell failure occurs at 0.6 mA·cm⁻². Here, lithium dendrite penetration occurs through both LLZTO discs relatively easily, without any evidence of partial shorting and recovery. A pressurized dendrite in the first LLZTO layer will not lead to a stress field in the second LLZTO layer (i.e., there is no load transfer) when a liquid electrolyte interlayer is used. In contrast, if localized lithium dendrite deflection occurs at a solid interlayer, a different overpotential signature will manifest to reflect this. With this in mind, the results with the c-LLZTO cells are important because they demonstrate that dendrite deflection is not occurring when there is no load transfer between the layers.

The PEO interlayer has weak interfacial adhesion and a low elastic modulus, both of which promote deflection, as indicated by Equation 5. The low adhesion energy between PEO and LLZTO was measured independently with a peel test. The results in the SI show that this adhesion energy is approximately 6 J/m², which is much lower than the estimated PEO fracture resistance (RL in Equation (5)) of ˜2400 J/m² (Maccaferri, E., et al., New Application Field of Polyethylene Oxide: PEO Nanofibers as Epoxy Toughener for Effective CFRP Delamination Resistance Improvement, ACS Omega, 2022, 7(27): p. 23189-23200) (calculated through measured values of its elastic modulus and K_{Ic}). Based on this comparison, pure mechanical loading should induce crack deflection at this PEO/LLZTO interface, and by analogy lithium dendrite deflection is also expected. FIG. 4B shows the electrochemical response of the PEO-LLZTO cell from plating-only cycles. At ˜0.85 mA/cm², there is a small decrease in the overpotential, indicating that a localized lithium dendrite has likely penetrated through the top LLZTO layer and reached the PEO interlayer. This distinctive overpotential drop occurred in all PEO-LLZTO cells that were tested. The overpotential value then stabilizes, which is consistent with temporarily trapping the lithium dendrite at the PEO interlayer interface without further penetration into the bottom LLZTO. The cell in FIG. 4B then finally experiences a total short at 1.05 mA/cm², which corresponds to eventual catastrophic dendrite penetration through the second LLZTO layer. Data for the two other configurations using polymer electrolytes (PVDF-LLZTO and rGO-PEO-LLZTO), presented in the SI, provides additional evidence for the deflection phenomenon.

The rGO materials, similar to the polymer materials, are expected to exhibit weak bonding to oxide materials, with adhesion energies on the order of ˜10 J/m² (Kumar, R., et al., Thermally reduced graphene oxide film on soda lime glass as transparent conducting electrode, Surface & Coatings Technology, 2017. 309: p. 931-937; Kang, D. W., et al., Enhanced adhesion and corrosion resistance of reduced graphene oxide coated-steel with iron oxide nanoparticles, Applied Surface Science, 2023, 624). FIG. 4C shows the electrochemical data for the rGO-LLZTO cell configuration. At a current density of 0.6 mA·cm⁻², a dramatic overpotential decrease from ˜650 mV to ˜200 mV occurs. Similar to the PEO cells, this is consistent with localized lithium dendrite penetration through one LLZTO layer. After reaching the interlayer, the cell overpotential then remains relatively stable for subsequent cycling. This is consistent with lithium dendrite “deflection” along the rGO/LLZTO interface. This phenomenon resembles the PEO results, but the additional limited electronic conductivity of the rGO material precipitates simultaneous qualified lithiation of the rGO interlayer (somewhat similar to the expected lithium alloying of the Indium metal interlayer). This implies that dendrite deflection here is affected by the synergistic mechanical and electrochemical phenomena.

This phenomenon, present in all rGO-LLZTO cells, shows that the key advantage of the rGO-LLZTO design is that it can continue to cycle normally at high current densities despite dendritic penetration through one LLZTO layer.

In contrast, the In-LLZTO (fully metallic interlayer design) shows cell failure at 0.6 mA/cm⁻² with no evidence of a partial short or dendrite deflection (FIG. 4D). Indium metal is known to have strong adhesion to oxide ceramic materials (Straessle, R., et al., Low-temperature thin-film indium bonding for reliable wafer-level hermetic MEMS packaging, Journal of Micromechanics and Microengineering, 2013, 23(7); Straessle, R., et al., Evaluation of Thin Film Indium Bonding at Wafer Level, Procedia Engineering, 2011, 25). This property should preclude dendrite deflection due to weak interfacial bonding. In In-LLZTO, as the lithium dendrite penetrates through one LLZTO half and reaches the Indium interlayer, the high electronic conductivity of the Indium (˜107 S/m) should allow rapid lithiation of the entire interlayer (i.e., forming an In—Li alloy). There is no evidence of this in the electrochemical response, suggesting that direct lithiation of the metal interlayer does not alter the dendrite penetration path. This indicates that dendrite penetration into the lower layer occurs rapidly.

FIG. 4E compares the CCD and total lithium capacity for the various interlayer-engineered electrolytes that were investigated. Additional details (including symmetric plating/stripping cycling tests) for all of these materials can be found in the SI. The overall results indicate that dendrite deflection occurs at all weakly bonded interfaces. Virtually all of these specimens (>20) exhibited the partial short associated with dendrite penetration of only the first LLZTO layer. The rGO interlayer enabled a particularly large increase in the CCD, and additional investigations were conducted with these materials to provide additional insight.

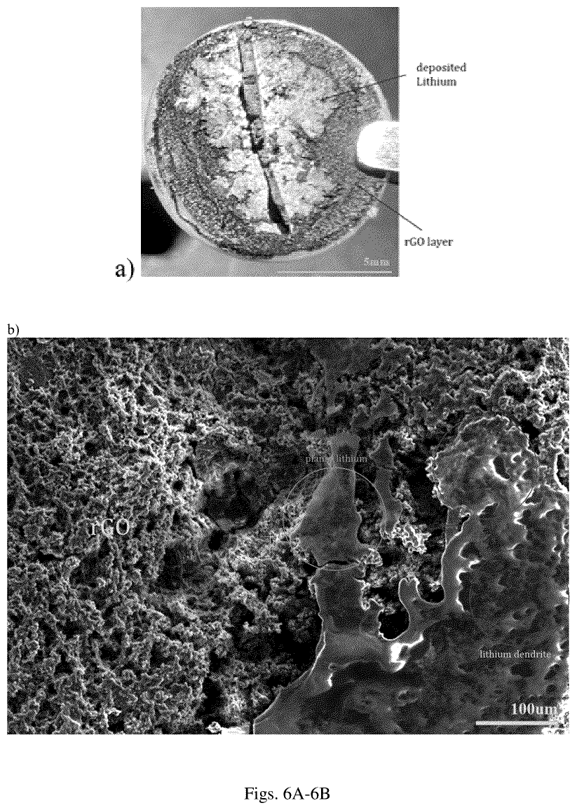

As lithium metal is intercalated into rGO, a distinct voltage shift can be observed in rGO relative to the lithium metal electrode (Yash Joshi, et al., Critical roles of reduced graphene oxide in the electrochemical performance of silicon/reduced graphene oxide hybrids for high rate capable lithium-ion battery anodes, Electrochimica Acta, Volume 404, 2022, 139753; Long Liu, et al., Enhanced Stability Lithium-Ion Battery Based on Optimized Graphene/Si Nanocomposites by Templated Assembly, ACS Omega, 2091, Vol 4/Issue 19), and is evident in the rGO lithiation test shown in FIG. 5C. In these lithiation experiments, a constant discharge current of 0.1 mA·cm⁻² was administered to gradually plate lithium into the rGO layer. The voltage profile begins at ˜2.6V but drops rapidly as lithium plating in the rGO occurs. After 1 hour, the voltage profile reaches a plateau of −0.15 V. This low OCV of −0.15V indicates that lithium is fully plated within the rGO interlayer, as the voltage measurement is essentially now a measure of a lithium-lithium symmetric cell. This unique rGO voltage response to lithium plating can be treated as direct evidence of lithium metal intercalation into the rGO.

In order to observe voltage changes in the engineered rGO interlayer, three-electrode cells were built as shown in FIGS. 5A-5B. These three-electrode cells are essentially identical to previous i-LLTZO cells, albeit with an additional copper tab in contact with the rGO interlayer extending out of the coin cell acting as a third electrode. With this cell configuration, OCV measurements can be taken intermittently during cycling between the third electrode and the counter lithium electrode to observe how the voltage fluctuates in the rGO interlayer as it becomes lithiated. To begin testing, the three-electrode cell was run with identical i-LLTZO plating-only cycling parameters as in FIG. 3A. For ease of comparison, both the cell overpotential during plating-only cycles and the third electrode OCV are plotted against time in FIG. 5D. OCV measurements were taken every 5 hours between 0-30 hours and 45-55 hours, and every hour between 30-45 hours. Commencing at the 32^{nd} hour, there is a distinct drop in the cell overpotential from 830 mV to 430 mV, indicating a shorting event occurring as the lithium begins to rapidly plate within the rGO. This event corresponds to a current density of 0.85 mA·cm⁻². Prior to this shorting event, the OCV remains fixed at ˜2.1V, but immediately drops when the cell begins to short. At the 40^{th} hour, the OCV begins to stabilize at −0.15V. The three-electrode cell OCV voltage response shows a voltage response nearly identical to the rGO lithiation reference experiment, with coinciding characteristics such as a sharp voltage decline at the beginning of lithiation, followed by voltage stabilizing and plateauing at a low overpotential, indicative of lithium being fully plated on the rGO surface. Accordingly, the rGO interlayer is successfully being lithiated and plated with lithium during plating-only cycles.

### Example VII

### Ex-situ Optical, SEM, and EDS Results

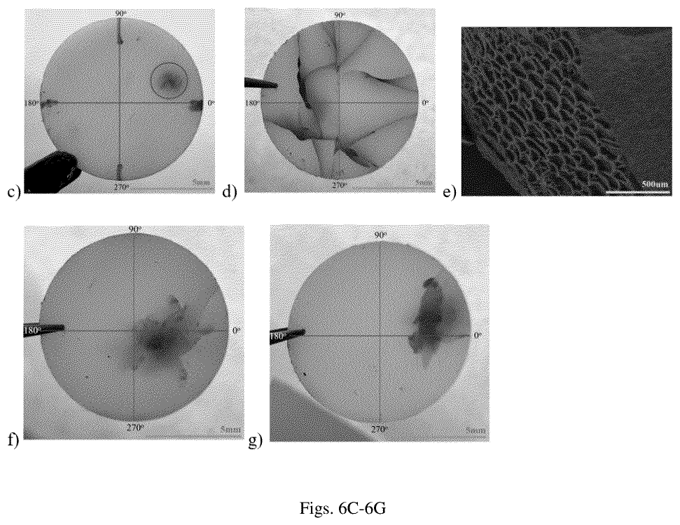

After plating-only sequences, the i-LLTZO cell was carefully taken apart in an Argon environment. The LLTZO pieces were separated, exposing the rGO interlayer. FIG. 6A shows a top-down view of the rGO layer coated on the top LLTZO piece. Clear evidence of planar lithium spread can be seen on the rGO interlayer (the central vertical straight line being a removal artifact). FIG. 6B shows a detailed SEM image depicting three different forms of lithium within this rGO interlayer. These images suggest that upon reaching and plating within the rGO interlayer, the lithium first intercalates into the rGO porous structure, then plating uniformly on its surface.

The plated lithium and rGO layer were then carefully removed with fine-grain polishing paper to expose the LLTZO underneath. FIG. 6C shows the top LLTZO piece, which exhibits a clear dendritic spot in the upper right quadrant, circled in red, indicative of a dendrite penetrating transversely through the top LLTZO disc at this localized point. Once lithium reaches and disperses within the middle rGO interlayer, dendrites now have this entire dispersed spectrum to choose from as nucleation “hot spots.” As a result, multiple dendrites grow through various locations originating from this lithium-filled interlayer, allowing the dendrites to penetrate across the entire surface of bottom LLTZO rather than only localized penetration seen in the top LLTZO piece. This leads to a distinctive dendrite-web structure with much longer and conspicuous dendritic lines, shown in FIG. 6D. The LLTZO disc was then meticulously broken apart precisely along one of these dendrite lines. Upon examination of the dendrite cross-section, clear evidence of the honeycomb-esque lithium morphology is exhibited, as shown in the SEM cross-section image in FIG. 6E.

A P-LLTZO cell was also carefully taken apart in an Argon environment, and the top and bottom LLTZO pieces searched for dendritic penetration evidence. The results are shown in FIGS. 6F-6G. Minimal lithium was found to be dispersed on the PEO interlayer surface. Furthermore, unlike i-LLTZO, in which the bottom LLTZO piece showed a web-like pattern of dendritic lines across the entire LLTZO pellet, the dendritic penetration location on the top and bottom LLTZO piece in the case of P-LLTZO are both localized. The dendrite locations are also in the vicinity of each other in the right half of the LLTZO disc. Both the lack of lithium and the dendrite penetration locations indicate that the dendrite was minimally deflected along the PEO interlayer when it penetrated through to the bottom LLTZO piece. A nearly identical phenomenon was observed for the PVDF-LLTZO cell. No lithium was found to be present in the c-LLTZO interlayer. As the LLTZO discs were bonded only by liquid electrolyte but with no substantial interlayer, dendrite penetration occurs transversely rapidly and shorts the cell at much lower current densities.

Upon taking apart and examining the i-P-LLTZO cell, which had both a PEO and rGO interlayer, lithium metal spread was found to be present on the interlayer, though in a much smaller capacity. This, combined with the phenomenon seen with the P-LLTZO cell, indicates that rGO, rather than PEO, is primarily responsible in enabling dendrite deflection.

The ionic conductance of a solid electrolyte is given by the equation G=σᵢA/t, where σᵢ is the ionic conductivity, the surface area, and the thickness of the solid electrolyte. Higher ionic conductance is correlated with higher critical current density, so lowering the thickness of the SE is critical for commercial applications. As the thickness of a single LLTZO disc used in this study was 600 μm thick, the total thickness of the laminated electrolytes was thus predominantly >1 mm thick. This thickness requires a higher voltage being applied in order to reach reasonable current densities, resulting in a relatively high electrochemical impedance of the overall electrolyte. This high voltage also leads to more surface perturbation and expedites nucleation of lithium dendrites. The present disclosure contemplates that with a thinner electrolyte, the dendrite arrest properties of the laminated electrolyte may be increased. The present disclosure also contemplates multiple interlayers or multiple laminated interlayers.

### Example VIII

### Mechanics of Dendrite Propagation

The present disclosure contemplates a model of electro-chemo-mechanics at a bi-material interface to explain the dendrite deflection phenomena observed in the engineered interlayers described herein.

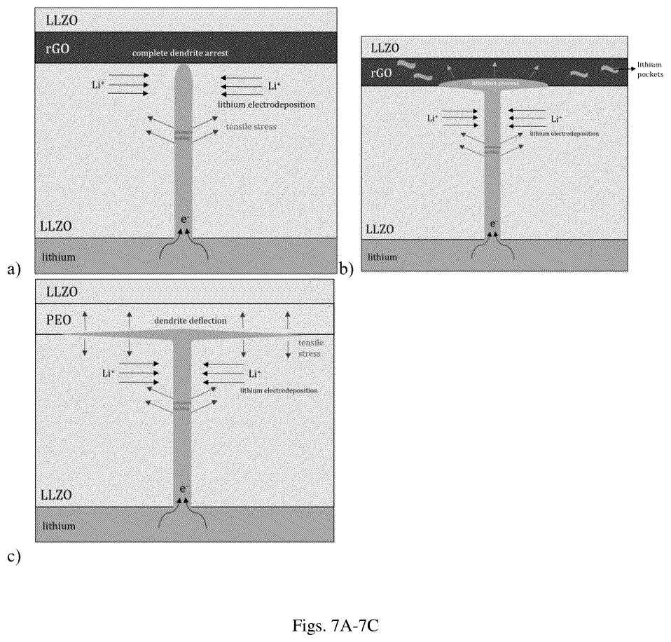

Recent studies have suggested that dendrite propagation within a ceramic solid electrolyte such as LLTZO can be rendered as a crack propagation problem (Porz, L. et al. Mechanism of lithium metal penetration through inorganic solid electrolytes, Adv. Energy Mater 7, 1701003 (2017); Cole D. Fincher, et al., Controlling dendrite propagation in solid state batteries with engineered stress, Joule, 2022, Volume 6, Issue 12, pages 2794-2809; Chunhao Yuan, Wenquan Lu and Jun Xu, Unlocking the Electrochemical-Mechanical Coupling Behaviors of Dendrite Growth and Crack Propagation in All-Solid-State Batteries, Advanced Energy Materials, 2021; Markus Klinsmann et al., Dendritic cracking in solid electrolytes driven by lithium insertion, Journal of Power Sources, 2019). At the onset of lithium plating, inhomogeneous current distribution leads lithium to preferentially deposit in the surface defects of the LLTZO at the Li-LLTZO interface. These surface irregularities become localized “hotspots” for lithium dendrite nucleation. Once these defects fill with lithium, a dendrite in the shape of a vertical “crack” with an elliptical tip begins to form, as seen in FIG. 7A. Griffith crack theory deems that there is an inherent tensile stress loading within the crack. To alleviate this stress loading, the lithium-filled crack expands forward infinitesimally. However, as more lithium infiltrates into the crack, high pressure is rapidly restored within the crack, causing it to extend forward once again. This continuous cycle results in the propagation of the lithium dendrite through the LLTZO. This process happens quite rapidly. The pressure loading within a lithium-infused dendritic “crack” may reach the order of 1 GPa in under 20 seconds (Markus Klinsmann et al., Dendritic cracking in solid electrolytes driven by lithium insertion, Journal of Power Sources, 2019). LLTZO with surface defect sizes of 30-50 um experience dendrite growth starting from overpotentials of 12-18 mV, which are surpassed even at an initial lowest cycling current density of 0.1 mA·cm⁻². Thus, cycling at even small current densities is sufficient to create lithium-plating stresses that can propagate lithium metal filaments.

FIGS. 7A-7C depict the possible mechanical mechanisms associated with electrochemical plating in a surface crack of a ceramic electrolyte such as LLTZO. Both the enhanced electric field and hydrostatic stress at the dendritic tip bring about dendritic propagation and growth.

There has also been an extensive amount of research conducted regarding the performance of laminated composite materials in mitigating crack propagation. For example, it has been proposed that a crack approaching an interface from a laminated material may prefer to deflect into the interface rather than to continue across it. It has also been proposed that the outcome of the competition between crack penetration through the laminated interlayer into the substrate versus interfacial deflection is determined by comparing the fracture resistance and energy release rates of the interlayer and substrate materials. It has also been proposed that stress redistribution at the laminated interfaces and a unique process zone ahead of the crack tip leads to interface delamination and crack deflection at the interface. Upon reaching the interface, the cracks begin growing along the interfacial direction, until further delamination causes it to penetrate through to the substrate. This crack deflection is a result of local heterogeneities at the interfaces, such as differences in the yield stress, elastic modulus, young's modulus, and the electrical and ionic conductivity, between the layered materials that allow for a unique toughening mechanism that retards crack propagation at the vicinity of these interfaces and allows for crack growth along this interface.

### Example IX

### Dendrite Arrest at a Bi-Material Interface

With reference to FIG. 7A directed to dendrite propagation via electrolyte fracture, the premise is that the lithium pressure builds up due to plating in the metal filament and applies normal stress along the dendrite/SE interface, σₓₓ^{flaw} (y). The Mode I stress intensity factor (SIF) for this internal loading is given by:

$${K}_{I}^{f} ≅ ψ \sqrt{π c} {\overline{p}}_{eff} \qquad ( 1 )$$

where:

$${\overline{p}}_{eff} = \frac{2}{π} {\int }_{0}^{c} \frac{{σ}_{xx}^{flaw} ( y )}{\sqrt{{c}^{2} - {y}^{2}}} d y \qquad ( 2 )$$

and p̅_{eff} is the effective pressure needed for crack propagation, c is the void size, and ψ is a factor that depends on the crack geometry. For the planar edge crack in FIG. 9A, ψ≅1.12. The corresponding strain energy release rate due to dendrite propagation is then given by:

$$G = \frac{{K}_{I}^{2}}{{E}_{SE}^{′}} \qquad ( 3 )$$

where E′_{SE} is the plane strain modulus of the electrolyte. Fracture of the electrolyte is expected (thermodynamically) when G exceeds the fracture resistance of the material. This condition is generally defined by the critical SIF, K_{Ic}:

$${K}_{I}^{f} > {K}_{Ic} \qquad ( 4 )$$

For a dendrite that propagates under this condition, the fracture process can be halted at an interface with a different material that has a higher toughness. However, this type of crack arrest should only occur under very limited conditions. To see this, consider dendrite initiation from a lithium Li filled void of size cₒ, which has to satisfy:

$$ψ \sqrt{π {c}^{o}} {\overline{p}}_{eff} ( {c}^{o} ) \geq {K}_{Ic}^{S} \qquad ( 5 )$$

where the equality corresponds to the minimum pressure required for crack propagation, given by:

$${\overline{p}}_{eff}^{o} = {\overline{p}}_{eff} ( {c}^{o} ) = \frac{{K}_{Ic}^{S}}{ψ \sqrt{π {c}^{o}}} \qquad ( 6 )$$

Once crack extension begins, this process creates internal space that will reduce pressure in the Li filament, but this is offset by the flux of additional lithium into the filament. Dendrite propagation will continue when the pressure reaches the fracture limit, which corresponds to a more general version of the equality in Eq. (6):

$${K}_{I}^{f} ( c ) = ψ \sqrt{π c} {\overline{p}}_{eff} ( c ) = {K}_{Ic}^{S} \qquad ( 7 )$$

This relationship implies that the internal pressure (p̅_{eff}) associated with the fracture threshold decreases as c increases. For crack extension that is initiated according to Eq. (5), this leads to the following relationship:

$${\overline{p}}_{eff} ( c ) = \sqrt{\frac{{c}^{o}}{c}} {\overline{p}}_{eff}^{o} \qquad ( 8 )$$

The decrease in the required pressure as crack extension proceeds implies that with a fixed voltage or current density, crack extension in a homogeneous material (i.e., with a fixed value of K_{Ic}^{S}) will continue once it has been initiated. As noted elsewhere, this is enhanced further by current focusing at the tip of the metal.

When a growing dendrite reaches the interlayer (c=h), propagation normal to the interface is dictated by the fracture toughness of the second material, K_{Ic}^{I}:

$$ψ \sqrt{π h} {\overline{p}}_{eff} ( h ) \geq {K}_{Ic}^{I} \qquad ( 9 )$$

Crack arrest will occur if this condition is not satisfied. This generally requires K_{Ic}^{I}>K_{Ic}^{S}, however, even when this is satisfied crack arrest may only be a transient condition, since Li plating into the filament can increase p̅_{eff}(h) to the point where Eq. (9) is satisfied. Crack arrest that persists requires that p̅_{eff}(h) stay below the value in Eq. (9), which can occur under conditions where the pressure is thermodynamically limited. To see this, note that the lithium plating overpotential along the length of the filament is given by:

$$η ( y ) ≅ {Δϕ}_{P} ( y ) - \frac{\overline{{V}_{L ι}}}{ℱ} {σ}_{xx}^{flaw} ( y ) \qquad ( 10 )$$

where Δϕ_{P}(y) is the potential difference across the SE/Li interface. Thus, the local equilibrium condition ηy)≅0 and the local electric field define the stress profile where there is no flux of Li into the dendrite:

$${σ}_{xx}^{max} ( y ) ≅ \frac{ℱ}{\overline{{V}_{L ι}}} {Δϕ}_{P} ( y ) \qquad ( 11 )$$

Inserting this into Eq. (2) defines the thermodynamically limiting value of p̅_{eff}^{max}, such that the requirement for crack arrest is:

$$ψ \sqrt{π h} {\overline{p}}_{eff}^{max} < {K}_{Ic}^{I} \qquad ( 12 )$$

The value of p̅_{eff}^{o} for dendrite initiation provides a convenient upper bound on p̅_{eff}^{max} (i.e., since p̅_{eff} decreases as crack extension proceeds, as noted after Eq. 7). This value gives a corresponding lower bound value, K_{Ic}^{I}*, that is needed for crack arrest:

$${K}_{Ic}^{I *} > \sqrt{\frac{h}{{c}^{o}}} {K}_{Ic}^{S} \qquad ( 13 )$$

In general, this requires a large K_{Ic}^{I}/K_{Ic}^{S} ratio since layer thicknesses are generally expected to be much larger than initiation flaw sizes (i.e., h/c^{o}>10 or more). Also, p̅_{eff}^{max} can clearly exceed p̅_{eff}^{o} (due to current focusing and other possible effects), and this will then lead to higher values than those in Eq. (13), thereby making it difficult to satisfy this condition.

### Example X

### Dendrite Deflection at a Bi-Material Interface

The assessment of penetration versus dendrite arrest that is outlined above assumes that the interface between the two materials is relatively strong. Fracture mechanics also defines conditions that will lead to crack deflection at an interface (See FIG. 7B), rather than the penetration case that is considered above. This generally requires a relatively weak interface and is logical to expect that this can lead to dendrite deflection as well. The energy-based criteria for this behavior has been analyzed by others. For materials with the same elastic modulus, this gives:

$$\frac{{Γ}_{D}}{{Γ}_{I}} < ∼ \frac{1}{4} \qquad ( 14 )$$

where σ_{I} and Γ_{D} are the fracture resistance for the interlayer material and the deflected (interface) crack, respectively. Note that the Γ_{I} is equivalent to K_{Ic}^{I} via the standard relationship:

$${Γ}_{I} = \frac{{{K}_{Ic}^{I}}^{2}}{{E}^{′}} \qquad ( 15 )$$

where E′ is the plane strain modulus. This deflection criterion is based on the presence of an initial small putative crack at the interface.

According to the present disclosure, for Li metal penetration, a deflection event can be treated similarly, since the initial (negligibly sized) deflected crack should not significantly alter the electric field. However, after initial deflection occurs, the propagation of this dendrite should differ from a deflected crack in several key ways. The pressure build-up inside of the deflected dendrite will create an elastic driving force that favors propagation along the interface. Thus, the stress-field at the crack tip will initially include contributions from the pressure in both the interlaminar and the pre-deflection filaments (see FIG. 7B). The latter will dissipate as the tip moves further along the interface, and thus the stress field will approach pure Mode I loading (due to the internal pressure) after the deflected crack has run far enough.

During through-thickness fracture of layered structures, a crack that deflects along an interface typically kinks out of the interface at a later position. Lithium filled dendrites are likely to exhibit similar behavior, in ways that ultimately lead to a short circuit (analogous to complete through thickness fracture of a laminate). For both cases, “kinking” (propagation out of the interlayer) is generally attributed to defects that can initiate fracture along a different path. The increased mode I character of interlaminar dendrites that is described above should reduce the driving force for dendrite kinking. However, electric field effects can potentially enhance the tendency for kinking. The tradeoff between these elastic and electric field effects are expected to require more detailed analysis of specific configurations and relevant material properties.

### Example XI

### Electronically Conducting Interlayer (e.g. rGO) and Role of the Interlayer in Arresting Dendrite Penetration

The analyses in Examples IX and X assume that both materials are solid electrolytes. The rGO layers differ from this because they are also electronically conductive. While the fracture processes in FIGS. 7A and 7B are also applicable to this situation, electronically conductive interlayers will behave differently when they are in contact with a lithium filament. When the metal tip reaches the interlayer, the electrons that are now available should lead to lithiation of the rGO. The schematic in FIG. 7C illustrates several expected behaviors, starting with a lithiation front that starts at the tip and moves out into the interlayer. Localized lithiation might also occur away from this region, due to inhomogeneities in the interlayer material. When there is extensive lithiation, a lithiated front in the interlayer can move laterally across the specimen (see FIG. 7C). The latter has some similarities to the deflected lithium filament shown in FIG. 7B, in that pressure should build up as lithiation proceeds. However, now this occurs in the lithiated rGO material, rather than in an interlaminar metal filament. It is not clear if this pressure build-up will lead to fracture-like propagation along the interlayer. It is possible (and perhaps likely) that the propagation of this lithiation front will instead be largely associated with direct lithiation of the active material. This will generate pressure (i.e., compressive stress) inside of the lithiated material, and a tensile stress in front of the lithiation front. The latter will again tend to evolve towards predominately Mode I loading as the tip of the lithiated region moves away from the initial dendrite contact with the interlayer. These stresses in this material can potentially impact the lithiation process (e.g., via elastic contributions to the chemical potential, etc), however, this may occur without fracture.

The laminated composite material of the present disclosure takes advantage of a specially designed rGO interlayer to initiate dendrite deflection when treated as a Griffith-type crack. In the case of a mixed ionic-electronic conductor, such as rGO, the lithium preferentially grows along this rGO/LLTZO interface to relieve pressure buildup in the dendrite; it also preferentially enters the rGO itself, which itself can be treated as an electron source, to create pockets of lithium within the rGO. The electronic conductivity of the rGO and the non-uniform electric field distribution drives lithium nucleation within the rGO interlayers, until most of the rGO is intercalated with lithium. Because the local electronic conductivity of the rGO interlayer is high, once the lithium encounters the rGO, the electrochemical potential will drop to a voltage similar to that of the Li plating counter electrode, and Li will preferentially nucleate and develop within and on top of the rGO layer. Furthermore, as the rGO does not have a high interface energy against Li, there is little barrier to homogeneous nucleation of Li on the rGO surface. This is shown in FIG. 2A. In the non-conductive case, the pure polymer PEO layer allows for some form of this crack deflection, but the strong interfacial bonding between the PEO/LLTZO interfaces and non-electrically conductive interlayer leads to little lithium-interlayer interaction, and the lithium dendrite is much less affected by the interlayer.

### Example XII

### FEM Simulations

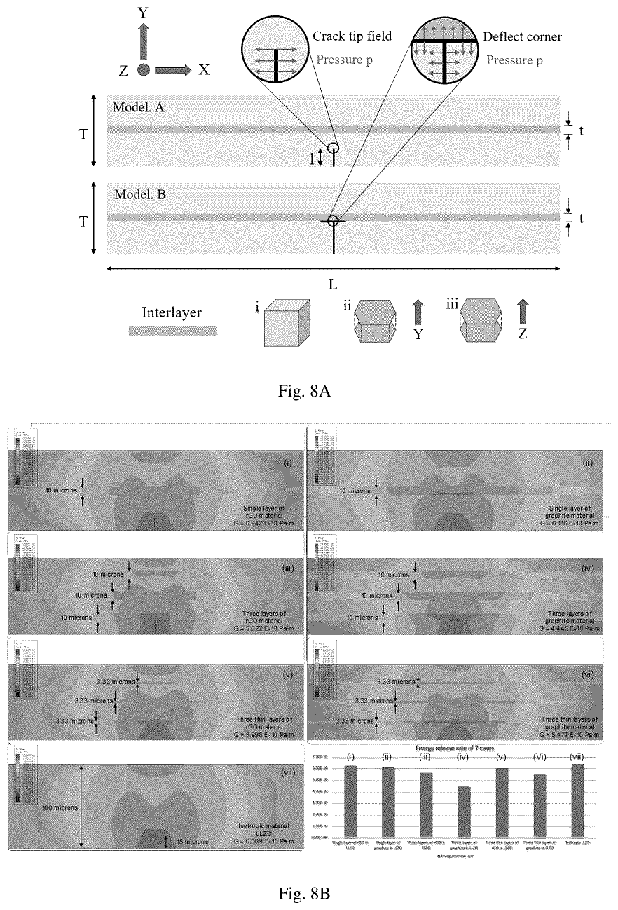

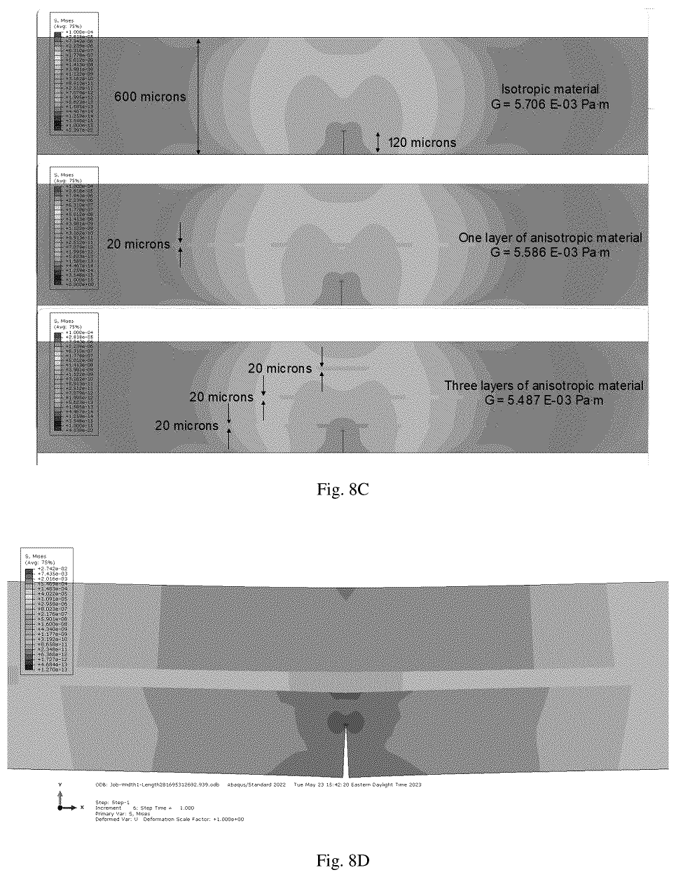

FEM models were built to simulate multiple rGO interlayers within a laminar LLTZO matrix to observe dendrite deflection capabilities. Stress and bending are much more prominent in a thinner electrolyte. FIGS. 8A-8D provide results of the FEM modeling that are consistent with the deflection abilities of materials with the same mechanical properties of rGO and LLTZO.

### Example XIII

### Expanded Study of rGO Interlayers

Three-electrode measurements were conducted to confirm that the rGO interlayer was lithiated after the initial overpotential drops that are attributed to dendrite penetration of the first LLZTO layer. These cells were constructed with a copper tab extending into the cell and in contact with the rGO interlayer (FIG. 9A). As a reference, an rGO lithiation reference cell was built to observe the voltage change of the rGO during direct lithiation (FIG. 9B). The copper tab in the three-electrode cell allows measurement of the voltage change of the rGO interlayer vs Li during cycling to compare with the lithiation curve of the lithiation control cell rGO. In FIG. 9B, the cell overpotential (black) experiences a rapid impedance drop that is indicative of lithiation of the rGO interlayer. This is nearly identical to the rapid drop in the voltage of the rGO interlayer vs lithium (red curve) in FIG. 9A, thus confirming that the rGO interlayer is indeed lithiated after dendrite penetration of the first LLZTO layer. As lithiation of the rGO interlayer is extremely localized and random, it was not be predicted where in the interlayer the rGO becomes lithiated; thus, copper wires were placed at random in this interlayer in multiple experiments. In the successful case shown here, the copper wire was in the immediate vicinity of the localized rGO lithiation to detect this voltage change, while many of the other measurements did not show evidence of lithiation. These combined results are consistent with lithiation of the rGO that is localized near the location where the dendrite penetrates through the first LLZTO layer.

The main advantage of the rGO-LLZTO design is its tolerance of high instantaneous current densities. However, longer symmetric lithium plating-stripping experiments were also used to evaluate the stability and longevity of the interlayer design. At a constant symmetric plating-stripping current of 0.5 mA·cm⁻² and 0.5 mAh·cm⁻² capacity/half cycle, the result for rGO-LLZTO in FIG. 9C shows stable cycling for over 500 hours without short circuiting. The small overpotential drop from ˜0.49V to ˜0.4V after 300 hours most likely indicates localized lithium dendrite penetration through one LLZTO disc. This is consistent with the proposed mechanism, where the dendrite is trapped in the rGO interlayer, and the cell continues to cycle stably for an additional 200 hours before shorting. In contrast, the c-LLZTO control cell (FIG. 9C, red curve) shorts after approximately 170 hours.

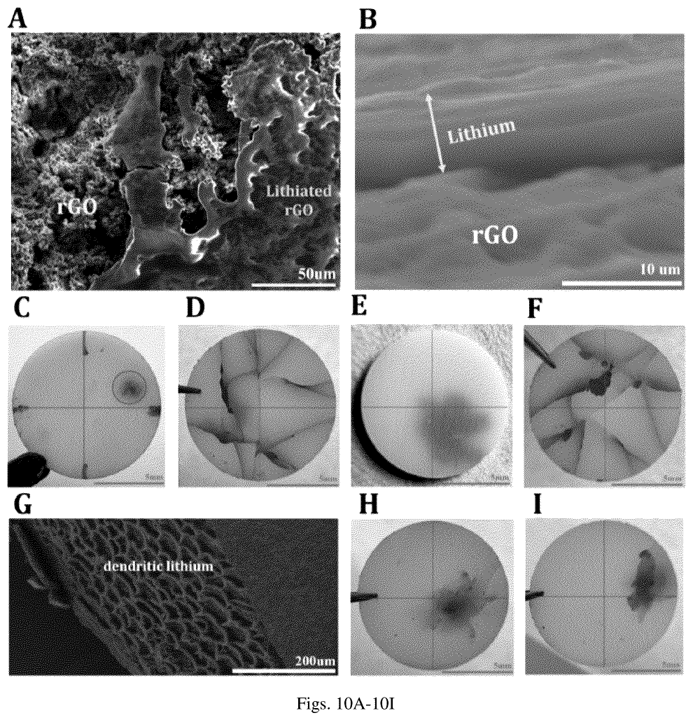

Post-mortem imaging of the samples is also consistent with successful dendrite deflection at the interlayer. The images in FIG. 5 show that lithium dendrite deflection at an engineered interlayer leads to dramatic differences in the dendrite penetration morphology. In all of these cases, lithium is plated on the top surface (i.e., the Li dendrite will grow from the top LLZTO disc and intersect the interlayer at the LLZTO (top)/interlayer interface). FIG. 10A shows metallic lithium intercalated into the rGO after lithium dendrite deflection. To image the LLZTO after shorting, the rGO and lithium were carefully removed. If lithium dendrite deflection occurs at the interlayer, the top and bottom LLZTO discs should show dendrite penetration sites at significantly different locations. The cross-sectional imaging in FIG. 10B shows a thin lithium layer on top of the rGO interlayer. In FIG. 10C, the dark region circled in red on the top LLZTO disk is indicative of a localized lithium dendrite penetration spot. This type of dark spot or line is often observed on LLZTO after shorting and demonstrative of a lithium dendrite (Cho, J. H., et al., An Investigation of Chemo-Mechanical Phenomena and Li Metal Penetration in All-Solid-State Lithium Metal Batteries Using in Situ Optical Curvature Measurements, Advanced Energy Materials, 2022. 12(19); Cheng, E. J., A. Sharafi, and J. Sakamoto, Intergranular Li metal propagation through polycrystalline Li_{6.25}Al_{0.25}La₃Zr₂O₁₂, ceramic electrolyte, Electrochimica Acta, 2017, 223: p. 85-91). The lower LLZTO piece from the same experiment (FIG. 10D) shows a drastically different pattern, with multiple penetration lines. This phenomenon is also observed for the PEO-LLZTO cell: In the top LLZTO piece (FIG. 10E), the lithium dendrite penetrates at a localized area in the bottom right quadrant. The lower LLZTO piece from the same experiment (FIG. 10F) also shows a multiple-penetration-line pattern. To confirm that these dark regions correspond to lithium dendrites, the LLZTO was carefully fractured directly along these dendritic “lines”. Examination of the cross-section of these dendritic lines show the characteristic “hexagonal honeycomb” or “web-like” morphology that has been widely reported for lithium dendrites in LLZTO (FIG. 10G). Our interpretation of the observations in FIGS. 10A-10G are that the primary lithium dendrite penetrates through the top LLZTO at a localized location, and that after deflection at the rGO or PEO interlayer, the lithium is dispersed laterally from this location. Penetration through the lower LLZTO piece then appears to occur via dendrite re-initiation at multiple sites in the lower LLZTO electrolyte.

This pattern of multiple penetration events is not observed in specimens where the electrochemical measurements do not show evidence of deflection, such as c-LLZTO. In c-LLZTO, the dendrite penetrates directly through the top and bottom LLZTO pieces with minimal change in dendrite path, and the dendrite penetration locales are generally aligned between the top and bottom pieces, as shown in FIGS. 10H and 10I. On the other hand, in both rGO-LLZTO and PEO-LLZTO, the disparity in the patterns on the top and bottom-(single vs multiple events) demonstrates that the PEO and rGO interlayer completely alter the dendrite penetration path. This is clear evidence of increased “damage tolerance” to lithium dendrite penetration through the solid electrolyte, due to dendrite deflection laterally across the interlayer instead of directly penetrating through the full multilayer SE. This is analogous to the enhanced fracture resistance and damage tolerance that is commonly obtained with multilayered composites or coatings (Cheng, L., et al., Structure design, fabrication, properties of laminated ceramics: A review, International Journal of Lightweight Materials and Manufacture, 2018, 1(3): p. 126-141; Ye, L. and X. Li, A dynamic stability design strategy for lithium metal solid state batteries, Nature, 2021, 593(7858): p. 218-222; Parmigiani, J. P. and M. D. Thouless, The roles of toughness and cohesive strength on crack deflection at interfaces, Journal of the Mechanics and Physics of Solids, 2006, 54(2): p. 266-287). With rGO and PEO interlayers, lithium plating at this upper interface is consistent with a weak interface and the deflection criteria as described in Example I.

### Example XIV

### Mixed Ionic-Electronic Conducting Interlayer (rGO)

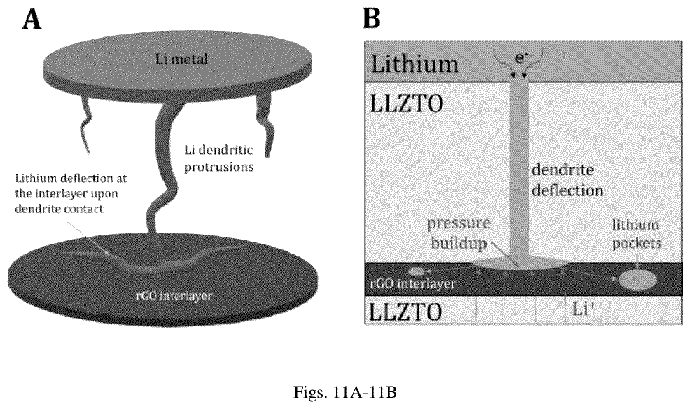

Of the materials that were investigated, the rGO interlayer is far better at mitigating dendrites. This is consistent with the mechanics analysis presented previously, in light of the fact that rGO has a high through-thickness fracture resistance and low interfacial adhesion with LLZTO. The PEO and rGO both have weak interfaces with LLZTO, and deflection is observed in both cases. However, rGO is a mixed ionic electronic conductor (MIEC), which suggests that this difference may be related to improved performance. While the In-LLZTO also employs a MIEC interlayer, deflection did not occur here, and the CCD was substantially lower. Although rGO and Indium are both mixed conductors, it appears that the Indium does not lead to dendrite deflection due to its high interfacial adhesion with LLZTO. The electronic conductivity of Indium metal is roughly six orders of magnitude higher than that of rGO, and thus this property does not appear to be the dominant factor that dictates dendrite deflection. These comparisons indicate that a weakly bonded interface is critical to deflection, but that mixed conduction may also play an important role in the improved deflection performance obtained with the rGO-LLZTO. A schematic illustrating the behavior observed in this material is shown in FIG. 11A. While the mechanics-based analyses of dendrite deflection still apply to this mixed conducting interlayer, an additional coupled electrical effect is also in play because rGO conducts lithium and also has a non-negligible variable electrical conductivity of 0.9-58 S/m (based on four-point probe measurements). Thus, once a dendrite reaches the interlayer, electron conduction through the lithium can enable lithiation of the rGO.

The electrical conductivity of the interlayer complicates the interpretation of electrochemical measurements, as the measured overpotential will be affected by contributions from both lithiation of the MIEC interlayer (near the dendrite) and normal plating that occurs far away from the dendrite. Addressing this in detail requires additional experiments and modeling. One important concern here is the overall amount of lithium that enters the rGO after dendrite penetration through the first layer. If this interlayer is fully lithiated it would effectively act like a working electrode. However, only limited lithiation of the Rgo was observed in our experiments. For example, in the case of the cell shown in FIG. 3C, only an estimated 6% capacity of the rGO interlayer is lithiated (see SI for quantitative details). This implies that the electrical conductivity in these materials is low enough to limit full lithiation.

The schematic in FIG. 11B illustrates several expected behaviors for the lithium dendrite after it reaches the rGO interlayer, starting with a lithiation front that begins at the tip and moves out into the interlayer. Localized lithiation might also occur away from this region, due to inhomogeneities in the interlayer material, shown schematically by the lithium “pockets.” This particular material has a complex structure with PVDF binder and some nanoscale porosity, which is expected to lead to uneven lithiation, possible void formation during de-lithiation, and a complex stress distribution inside of the interlayer. An examination of these effects is beyond the scope of the current study, although control of these heterogeneities, along with control of the electrical conductivity, could potentially enable the design of interlayers with even better performance. The progressive lithiation of rGO should also induce pressure buildup inside the interlayer as lithiation proceeds. However, with this occurring inside of the lithiated rGO material, the impact of internal pressure on fracture along the rGO/LLZTO interface is likely to be more complex. It is possible (and perhaps likely) that the propagation of a lithiation front will instead be largely associated with direct lithiation of the active material that will generate pressure (i.e., compressive stress) inside of the lithiated material, and a tensile stress in front of the lithiated region. It is also well-established that the electric field in a solid electrolyte (an electric insulator) focuses the lithium-ion flux at the dendrite tip, thus rapidly increasing internal pressure buildup at this tip and accelerating dendrite growth (as illustrated in FIG. 1A) (Santos, E. and W. Schmickler, The Crucial Role of Local Excess Charges in Dendrite Growth on Lithium Electrodes, Angewandte Chemie-International Edition, 2021, 60(11): p. 5876-5881; Aryanfar, A., et al., Dynamics of Lithium Dendrite Growth and Inhibition: Pulse Charging Experiments and Monte Carlo Calculations. Journal of Physical Chemistry Letters, 2014, 5(10): p. 1721-1726). Within an electrically conducting interlayer such as rGO, however, the electric field will be redistributed due to the excess available electrons. The corresponding lithium flux will be less concentrated at the dendrite tip, (illustrated in FIG. 11B) leading to decreased internal pressure at this tip, which could mitigate dendrite growth.

During traditional through-thickness fracture of layered composite structures, a mechanical crack that deflects along an interface will typically kink out of the interface, leading ultimately to complete through thickness fracture (He, M. Y. and J. W. Hutchinson, CRACK DEFLECTION AT AN INTERFACE BETWEEN DISSIMILAR ELASTIC-MATERIALS, International Journal of Solids and Structures, 1989, 25(9): p. 1053-1067; Ahn, B. K., et al., Criteria for crack deflection/penetration criteria for fiber-reinforced ceramic matrix composites, Composites Science and Technology, 1998, 58(11): p. 1775-1784). Lithium dendrites should exhibit similar behavior, in ways that might ultimately lead to a short circuit. For both cases, “kinking” is generally attributed to defects that can initiate fracture along a different path. The increased Mode I character of interlaminar lithium dendrites should reduce the driving force for dendrite kinking. Furthermore, the higher modulus of rGO (256.1 GPa) (Ni, J. E., et al., Room temperature elastic moduli and Vickers hardness of hot-pressed LLZO cubic garnet, Journal of Materials Science, 2012, 47(23): p. 7978-7985) compared to LLZTO (149.8 GPa) (Yu, S., et al., Elastic Properties of the Solid Electrolyte Li₇La₃Zr₂O₁₂ (LLZO), Chemistry of Materials, 2016, 28(1): p. 197-206) will promote dendrite deflection along the interlayer, and stress redistribution at the crack tip should drive crack deflection along the interface until further delamination causes through-thickness kinking (Pohl, P. M., et al., About the Role of Interfaces on the Fatigue Crack Propagation in Laminated Metallic Composites, Materials, 2021, 14(10)). However, when this concept is extended to lithium dendrites, electric field effects can potentially enhance the tendency for kinking. The tradeoff between these elastic and electric field effects requires detailed analysis of specific configurations and relevant material properties, including differences in elastic modulus, Poisson ratio, and the electrical and ionic conductivity between the interlayer and the solid electrolyte (Parmigiani, J. P. and M. D. Thouless, The roles of toughness and cohesive strength on crack deflection at interfaces, Journal of the Mechanics and Physics of Solids, 2006, 54(2): p. 266-287; Sundaram, B. M. and H. V. Tippur, Dynamics of crack penetration vs. branching at a weak interface: An experimental study, Journal of the Mechanics and Physics of Solids, 2016, 96: p. 312-332).

### Example XV

### Multilayer Simulations

The observed deflection of lithium at an interlayer within a solid electrolyte successfully demonstrates that a layered structure can improve the resistance of the material to lithium dendrite penetration. For the multilayered structures investigated here, this is seen in the continued stable cycling that occurs after an initial short through one solid electrolyte layer and in the post-mortem images. In principle, this proof-of-concept architecture can be extended to a generalized electrolyte design with multiple interlayers to enable the creation of a more “damage tolerant” structures. These materials would be analogous to multilayered architectures that have been widely used to improve fracture resistance in a conventional context. A finite element model (FEM) was constructed to further explore the potential advantages of this type of structure. This modeling also provides a detailed description of the stress distribution that arises when a dendrite reaches an internal interface. For this simulation, the cross-sectional surface of the LLZTO electrolyte is represented as a two-dimensional sandwich-like beam (of length L=10,000 μm and thickness T=100 μm) with interlayers (of total N layers and t=10/N μm thickness) and a dendritic crack (of length 1) at the midpoint of the beam. The dendritic crack is modeled as a zero-thickness seam subjected to constant pressure (constant lithium plating flux into the dendrite) as the driving force. A uniform pressure is applied to element surfaces along the seam crack in general static steps. The value of the pressure (on the order of 100 MPa) corresponds to that needed for crack propagation (see Methods Section for details) and is also consistent with direct experimental measurements (Fincher, C. D., et al., Controlling dendrite propagation in solid-state batteries with engineered stress, Joule, 2022, 6(12): p. 2794-2809; Athanasiou, C. E., et al., Operandomeasurements of dendrite-induced stresses in ceramic electrolytes using photoelasticity, Matter).

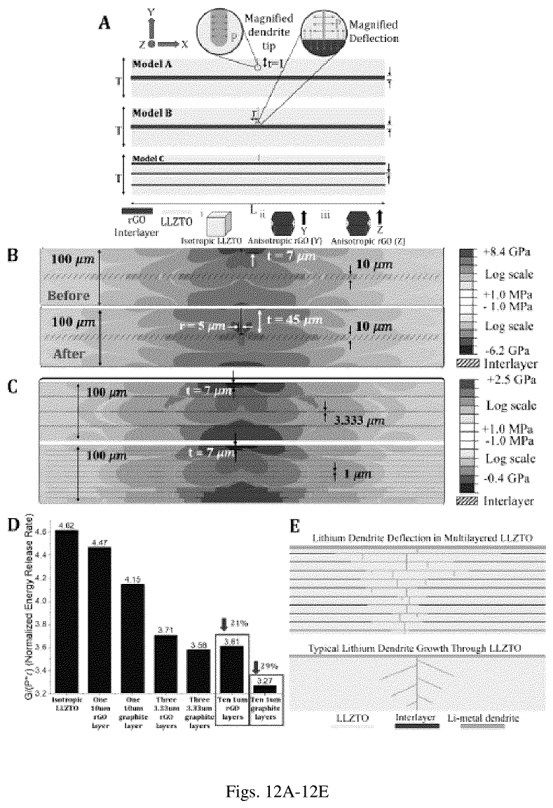

The three models in FIG. 12A each show different two-dimensional cross-sections of the LLZTO material with different interlayers. Model A shows rGO-LLZTO with a 10-μm thin rGO interlayer. A deflection event (of length r) of the crack upon reaching an interlayer is shown in Model B, using a similar seam-like crack. Model C is identical in construction to Model A, albeit with more interlayers. For a single interlayer, the stress fields in FIG. 12B show that the elastic fields are much larger than the interlayer thickness. For multiple interlayers, complex stress distributions will occur, shown in FIG. 12C. The results of the simulation are summarized in FIG. 12D and show that significant decreases in the energy release rate are expected with thin and stiff interlayer materials such as oriented graphite and rGO. With multiple engineered interlayers embedded into the electrolyte, the lithium dendrite potentially encounters deflection along at each interlayer (FIG. 12E), drastically improving the critical current density of the laminated electrolyte and exhibiting substantially better overall resistance to dendrite penetration than our initial proof-of-concept experiments. Adding more interlayers, however, will most likely decrease the overall ionic conductivity of the solid electrolyte, leading to higher overall cell impedance. This points to a crucial balance between dendrite inhibition and the overall impedance.

This work demonstrates that chemo-mechanical fracture concepts can effectively describe dendrite deflection at bi-material interfaces in multilayered solid electrolytes. This initial study also indicates that, counterintuitively, a limited electron conductor embedded in the inner structure of a composite solid-state electrolyte can be advantageous in effectively suppressing lithium dendrite penetration at high current densities. A fracture-based model is developed to determine the criteria needed for lithium dendrite deflection at an inner interlayer within a solid electrolyte. An experimental design was then constructed to verify this mechanical model. A variety of interlayer materials were examined, including polymer electrolytes and fully metallic interlayers. An rGO material as the interlayer led to the most successful case of lithium dendrite interlayer deflection, allowing for partial shorting of the cell but still stable cycling up to high critical current densities of ˜3.8 mA·cm⁻², which is more than six times higher than that of the control cell without an rGO interlayer. Based on analysis of the experiments and finite element modeling, we propose that the superior performance of the rGO material is associated with the following:
i) Deflection along the solid electrolyte/interlayer interface, due to a favorable strain energy release rate;
ii) High modulus and high through-thickness fracture resistance of the interlayer; and
iii) Limited electron conduction of the interlayer, leading to localized lithiation of the interlayer material, along with the redistribution of the electric field near the dendrite tip.

More broadly, these three mechanisms provide important guidelines for future design and optimization of multilayered solid electrolytes with superior properties.

### Example XVI

### Experimental Procedures

rGO-LLZTO Synthesis: graphene oxide (GO) was synthesized and purified in-house using a modified Hummer's method following the procedure in Spitz et al. (Steinberg, R. S., et al., Breathable Vapor Toxicant Barriers Based on Multilayer Graphene Oxide, Acs Nano, 2017, 11(6): p. 5670-5679). Monolayer GO nanosheets were harvested into aqueous stock suspensions of 1-3 mg/ml to use as an ink for film casting. A 75 μL aliquot of 0.5 mg/ml GO suspension was pipetted onto one side of a LLZTO pellet. An LLZTO pellet was placed in an oven at 60° C. for 15 minutes to partially dry before placing another, clean LLZTO pellet on top. The GO film, lying between the two adhered LLZTO pellets, was left to dry overnight before heating in a tube furnace at 150° C. for 2 hours for reduction.

PEO-LLZTO synthesis: PEO powder (MW. 1,000,000, Sigma Aldrich) was dried in a vacuum furnace at 60° C. for 48 hours to remove water and trace hydrates. To make the PEO solution, 20 mg of dried PEO powder stirred thoroughly in 4 mL of acetonitrile solution for 12 hours to form a PEO solution. To prepare the LLZTO for interlayer synthesis, polypropylene was painted along the edge of a LLZTO pellet to prevent solution leakage onto the sides to the LLZTO. The PEO solution was then drop-casted onto the surface of the LLZTO. When most but not all of the acetonitrile had evaporated, a second LLZTO piece was placed on top of the drop-cast PEO layer to complete the PEO-LLZTO electrolyte. Finally, the PEO-LLZTO was placed on a hot plate at 50° C. in the glovebox for adhesion and drying.

PVdF-HFP-LLZTO synthesis: PVdF-HFP powder was dried in a vacuum furnace at 60° C. for 48 hours to remove water and trace hydrates. To make the PVdF-HFP solution, 20 mg of dried PVdF-HFP powder was powder stirred thoroughly in 4 mL of acetonitrile solution for 12 hours to form a PVdF-HFP solution. As with the PEO-LLZTO, a polypropylene seal was created on the outer edge of a LLZTO pellet. The PVdF-HFP solution was then drop-casted onto the surface of the LLZTO. When most but not all the acetonitrile had evaporated, a second LLZTO piece was placed on top of the drop-cast PVdF-HFP layer to complete the PVdF-HFP-LLZTO electrolyte. Finally, the PVdF-HFP-LLZTO was placed on a hot plate at 50° C. in a glovebox for adhesion and drying.

In-LLZTO synthesis: 2.5 um of Indium metal was first deposited on LLZTO using thermal evaporator integrated with a glovebox (Angstrom Engineering, Canada). To prevent indium deposition on the edges of the pellets, one side of the LLZTO pellets was covered with Kapton tape featuring a 10 mm diameter hole in the center. This precautionary measure helps to avoid potential shorting between the working and countering electrodes. The deposition thickness was monitored using a Quartz Crystal Microbalance (QCM), with a deposition rate of approximately 3 Angstroms per second. This rate was controlled by adjusting the heating power to the crucible. Two pieces of this indium-coated-LLZTO pellets were then stacked under pressure with the indium in contact and heat treated at 225° C. in a glovebox to thermally bond the indium together. The resulting In-LLZTO was then cooled to room temperature.

c-LLZTO synthesis: c-LLZTO was created in a similar fashion to rGO-LLZTO and PEO-LLZTO. The edges of the LLZTO were coated with polypropylene to prevent liquid from leaking onto the sides of the ceramic discs. A drop of 0.6M Lithium bis(trifluoromethane) sulfonimide (LiTFSI) and 0.4M LiNO3 in Dioxolane (DOL)/Dimethoxyethane (DME) (1:1 volume ratio) liquid electrolyte was placed on the bottom LLZTO piece with a volumetric pipette. The second LLZTO disc was placed directly on top of this before drying.

rGO lithiation reference cell synthesis: A piece of copper foil was sonicated for 45 minutes in ethanol and dried thoroughly. The copper foil was punched to the same size as the LLZTO to act as the current collector. As with rGO-LLZTO, an LLZTO disc was heat treated at 500° C. for 4 hours and polished with a silica carbide polishing paper to remove contaminants from the surface. A 75 μL aliquot of 0.5 mg/ml GO suspension was pipetted onto one side of a LLZTO pellet. A copper current collector was placed on top of the drop-cast rGO layer to complete the rGO lithiation reference cell. The GO film was left to dry overnight before heating in a tube furnace at 150° C. for 2 hours for reduction.

Coin cell synthesis: The coin cell synthesis procedure is identical regardless of the different laminated electrolytes used. All cells were assembled in CR2032 type coin cells in an Argon-filled glovebox (O₂ and H₂O<0.1 ppm). The lithium metal foil surface was first brushed until shiny to remove contaminants from the surface. Lithium metal electrodes with a diameter of 6.5 mm were punched from the lithium metal foil and placed on both sides of the solid laminated electrolyte to create a Li∥Li symmetric coin cell. In order to maintain ionic contact between the lithium electrode and LLZTO surface during the duration of electrochemical cycling, a small drop (<10 uL) of 0.6M LiTFSI and 0.4M LiNO₃ in DOL/DME (1:1 volume ratio) liquid electrolyte was dropped onto the surface of the Li metal electrode on both sides in order for the cell to cycle at reasonable overpotentials. Likewise, the edges of the LLZTO were coated with polypropylene to prevent liquid from leaking onto the sides of the ceramic discs. This approach has been used in recent research to improve the surface wetting of the Li-anode/LLZTO surface (Mu, S., et al., Heterogeneous electrolyte membranes enabling double-side stable interfaces for solid lithium batteries, Journal of Energy Chemistry, 2021, 60: p. 162-168; Liu, M., et al., Garnet Li<sub>7</sub>La<sub>3</sub>Zr<sub>2</sub>O<sub>12</sub>-Based Solid-State Lithium Batteries Achieved by In Situ Thermally Polymerized Gel Polymer Electrolyte, Acs Applied Materials & Interfaces, 2022, 14(38): p. 43116-43126). The crux of this project is to investigate mechanical deflection of lithium dendrites, and thus additional surface interface modifications to improve overall performance were not used.

Three-electrode coin cell synthesis: Three-electrode cells are simply a slightly modified version of rGOLLZTO, with the only additional piece being the copper tab. The copper tab was first cut from a piece of thin copper foil. The tab was approximately 4 cm long and 0.5 cm wide. Kapton tape was used to fully wrap the middle section of the copper tab, exposing about 1 cm of copper on each end. The electrolyte synthesis is nearly identical to rGO-LLZTO. Before the second LLZTO piece is placed onto the bottom LLZTO disc and rGO interlayer, one end of the copper tab was carefully rested on the rGO interlayer. The second LLZTO piece was then placed on to cover the copper tab and the rGO. When sealing the coin cell, the middle section (with Kapton tape) of the copper tab is sealed in contact with the sides of the coin cell to avoid electrical contact.

Electrochemical Measurements: All electrochemical measurements were made after resting each coin cell for 2 hours. A battery cycler (Biologic, SP300) was employed to measure the voltage curves of the cells under plating-only sequences. The sequences were designed to begin plating at a current density of 0.1 mA·cm⁻² with a 1 mAh·cm⁻² capacity limit and with a ramp up step of 0.05 mA·cm⁻². Electrochemical impedance spectroscopy (EIS) measurements were conducted on a Biologic SP300 over a frequency range from 10⁻³ Hz to 10⁶ Hz using AC perturbation of 10 mV. Three-electrode OCV measurements were made by simply connecting a third electrode alligator clip to the extended copper tab. All electrochemical measurements were made at room temperature.

Post-Mortem Imaging: Each laminated electrolyte was marked into four quadrants by a permanent marker to better observe the discrepancy in the location of the dendritic penetration sites. The lithium plated on the rGO interlayer was imaged. P1200 grit silica carbide polishing paper was used to carefully polish off the excess lithium metal and rGO and expose the LLZTO discs underneath. The LLZTO discs were imaged. The thin razor blade was used to slice the LLZTO among a dendritic penetration line and examined with Scanning Electron Microscopy (SEM, ThermoScientific Quattro S ESEM) using an acceleration voltage of 10⁻²⁰ kV.

Finite Element Modeling Details: LLZTO is an isotropic material with two elastic constants. Previous works have calculated the shear modulus and Poisson's ratio. [49, 50] In this FEM simulation, the Young's modulus is calculated through the shear modulus and Poisson's ratio. As anisotropic materials, rGO and graphite are both tetragonal symmetric and possess 6 elastic constants each. A previous work (Riobóo, R. J. J., et al., Elastic constants of graphene oxide few-layer films: correlations with interlayer stacking and bonding, Journal of Materials Chemistry C, 2015. 3(19): p. 4868-4875) revealed all elastic constants for rGO and graphite at room temperature. In this study, elastic constants are transformed to engineering constants such as Young's modulus, shear modulus and Poisson's ratio, which are more widely used in simulation material property settings. Specific elastic constants used can be found in the SI.

A right-hand coordinate system was employed to delineate directions within interlayers due to rGO's unidirectional anisotropy. The X-Z plane in FIG. 7C represents the interfacial plane of the electrolyte and rGO interlayers. The Y direction represents the thickness of the multilayer electrolyte. Three material property scenarios are examined: 1) isotropic property using LLZTO's Young's modulus and shear modulus as a reference case; 2) anisotropic property using rGO's elastic constant; 3) isotropic property using graphite's elastic constant. The main geometry includes a limited number of CPE3 (three-node plane strain) elements and over 10,000 CPE4 (four-node plane strain) elements, while an additional 5,000 finer CPE4 elements are specifically positioned in the crack tip field to enhance J-integral calculations using the contour integral method.

The value of the pressure (on the order of 100 MPa) corresponds to that needed for crack propagation: Using the basic stress intensity factor equation and the fracture toughness of LLZTO to calculate the applied pressure:

$${K}_{1} = \frac{π}{2} p \text{?} = {K}_{1 C} = 1 MPa \sqrt{m} \to p = \frac{2 \text{?}}{π \text{?}} \approx 100 MPa$$

$$\text{?} \text{indicates text missing or illegible when filed}$$

Where √l is 45 μm (lower figure of FIG. 12A). For ease of comparison of the stress states between different cases with different interlayer numbers, the applied pressure in all cases is set at a fixed 100 MPa.

The energy release rate can be expressed as:

$$\text{?} = \frac{\text{?}}{{E}^{*}} = C \frac{{p}^{2} \text{?}}{E}$$

$$\text{?} \text{indicates text missing or illegible when filed}$$

Where constant C, the geometry coefficient, depends on the layer number of the electrolyte. In this case, our plotted dimensionless parameter is:

$$\frac{G}{pl} = C \frac{p}{E}$$

Reference for K_{Ic}: (Park, R. J. Y., et al., Semi-solid alkali metal electrodes enabling high critical current densities in solid electrolyte batteries, Nature Energy, 2021, 6(3): p. 314-322).

The energy release rate G in the crack tip field is calculated as the steps progress with the J integral method. Although the normalized energy release rate varies with applied pressure (since we the applied pressure was fixed at 100 MPa for all cases), the normalized energy release rate is now a function of only the geometry (i.e. the effect of different number of layers).

The studies described in the present application investigate mechanical lithium dendrite deflection with different interlayer materials. The results are consistent with fracture-mechanics-based analysis and demonstrate that stress-driven dendrites can be deflected at weakly bonded internal interfaces. Reduced graphene oxide interlayers show the most impressive improvements in electrochemical performance, with a six-fold increase in the critical current density.

### Example XVII

### Embodiments

The present disclosure provides a method of preventing lithium dendrite penetration through a lithium-based solid-state electrolyte including the steps of providing a reduced Graphene Oxide interlayer within the lithium-based solid-state electrolyte, and subjecting the lithium-based solid-state electrolyte with the reduced Graphene Oxide interlayer to a current density. According to one aspect, the current density is a critical current density of above 3 mA·cm⁻². According to one aspect, the lithium-based solid state electrolyte is a laminate of a lithium lanthanum zirconium oxide (LLTZO) solid state electrolyte and a reduced Graphene Oxide layer. According to one aspect, the reduced Graphene Oxide interlayer is a flexible, porous carbon matrix. According to one aspect, the reduced Graphene Oxide interlayer is a mixed ion-electron conductor. According to one aspect, the reduced Graphene Oxide interlayer is a porous carbon matrix and a mixed ion-electron conductor. According to one aspect, lithium dendrite, upon contact with the reduced Graphene Oxide layer, extends within the interlayer instead of continuing penetration through the lithium-based solid electrolyte. According to one aspect, the reduced Graphene Oxide interlayer is between 10 μm and 30 μm in thickness. According to one aspect, the reduced Graphene Oxide interlayer is about 20 μm in thickness. According to one aspect, the lithium-based solid-state electrolyte is a laminate of an LLTZO solid state electrolyte and a reduced Graphene Oxide layer, wherein the reduced Graphene Oxide layer is between a first lithium-based solid-state electrolyte portion and a second lithium-based solid state electrolyte portion. According to one aspect, the lithium-based solid-state electrolyte is lithium lanthanum zirconium oxide solid-state electrolyte. According to one aspect, the lithium-based solid-state electrolyte is tantalum-doped lithium lanthanum zirconium oxide solid-state electrolyte. According to one aspect, the lithium-based solid-state electrolyte is tantalum-doped lanthanum zirconium oxygen solid-state electrolyte having the formula Li_{6.4}La₃Zr_{1.7}Ta_{0.3}O₁₂.

The present disclosure provides a method of making an interlayered lithium-based solid electrolyte including the step of providing a lithium-based solid-state electrolyte with a reduced Graphene Oxide interlayer. According to one aspect, the interlayered lithium-based solid-state electrolyte is a laminate of a lithium lanthanum zirconium oxide (LLTZO) solid state electrolyte and a reduced Graphene Oxide layer. According to one aspect, the reduced Graphene Oxide interlayer is a flexible, porous carbon matrix. According to one aspect, the reduced Graphene Oxide interlayer is a mixed ion-electron conductor. According to one aspect, the reduced Graphene Oxide interlayer is a porous carbon matrix and a mixed ion-electron conductor. According to one aspect, the reduced Graphene Oxide interlayer is between 10 μm and 30 μm in thickness. According to one aspect, the reduced Graphene Oxide interlayer is about 20 μm in thickness. According to one aspect, the interlayered lithium-based solid-state electrolyte is a laminate of an LLTZO solid state electrolyte and a reduced Graphene Oxide layer, wherein the reduced Graphene Oxide layer is between a first lithium-based solid-state electrolyte portion and a second lithium-based solid-state electrolyte portion. According to one aspect, the lithium-based solid-state electrolyte is lithium lanthanum zirconium oxide solid-state electrolyte. According to one aspect, the lithium-based solid-state electrolyte is tantalum-doped lithium lanthanum zirconium oxide solid-state electrolyte. According to one aspect, the lithium-based solid-state electrolyte is tantalum-doped lanthanum zirconium oxygen solid-state electrolyte having the formula Li_{6.4}La₃Zr_{1.7}Ta_{0.3}O₁₂.

The present disclosure provides a lithium-based solid electrolyte having an interlayer of reduced Graphene Oxide. According to one aspect, the lithium-based solid electrolyte includes a laminate of a lithium lanthanum zirconium oxide (LLTZO) solid-state electrolyte and a reduced Graphene Oxide layer. According to one aspect, the reduced Graphene Oxide interlayer is a flexible, porous carbon matrix. According to one aspect, the reduced Graphene Oxide interlayer is a mixed ion-electron conductor. According to one aspect, the reduced Graphene Oxide interlayer is a porous carbon matrix and a mixed ion-electron conductor. According to one aspect, the reduced Graphene Oxide interlayer is between 10 μm and 30 μm in thickness. According to one aspect, the reduced Graphene Oxide interlayer is about 20 μm in thickness. According to one aspect, the reduced Graphene Oxide layer is between a first lithium-based solid-state electrolyte portion and a second lithium-based solid-state electrolyte portion. According to one aspect, the lithium-based solid-state electrolyte is lithium lanthanum zirconium oxide solid-state electrolyte. According to one aspect, the lithium-based solid-state electrolyte is tantalum-doped lithium lanthanum zirconium oxide solid-state electrolyte. According to one aspect, the lithium-based solid-state electrolyte is tantalum-doped lanthanum zirconium oxygen solid-state electrolyte having the formula Li_{6.4}La₃Zr_{1.7}Ta_{0.3}O₁₂.

The present disclosure provides a solid-state battery including comprising a lithium-based solid electrolyte having an interlayer of reduced Graphene Oxide. According to one aspect, the lithium-based solid electrolyte includes a laminate of a lithium lanthanum zirconium oxide (LLTZO) solid-state electrolyte and a reduced Graphene Oxide layer. According to one aspect, the reduced Graphene Oxide interlayer is a flexible, porous carbon matrix. According to one aspect, the reduced Graphene Oxide interlayer is a mixed ion-electron conductor. According to one aspect, the reduced Graphene Oxide interlayer is a porous carbon matrix and a mixed ion-electron conductor. According to one aspect, the reduced Graphene Oxide interlayer is between 10 μm and 30 μm in thickness. According to one aspect, the reduced Graphene Oxide interlayer is about 20 μm in thickness. According to one aspect, the reduced Graphene Oxide layer is between a first lithium-based solid-state electrolyte portion and a second lithium-based solid-state electrolyte portion. According to one aspect, the lithium-based solid-state electrolyte is lithium lanthanum zirconium oxide solid-state electrolyte. According to one aspect, the lithium-based solid-state electrolyte is tantalum-doped lithium lanthanum zirconium oxide solid state electrolyte. According to one aspect. the lithium-based solid-state electrolyte is tantalum-doped lanthanum zirconium oxygen solid-state electrolyte having the formula Li_{6.4}La₃Zr_{1.7}Ta_{0.3}O₁₂.

1. A method of preventing lithium dendrite penetration through a lithium-based solid-state electrolyte comprising
providing a reduced Graphene Oxide interlayer within the lithium-based solid-state electrolyte, and
subjecting the lithium-based solid-state electrolyte with the reduced Graphene Oxide interlayer to a current density.

2. The method of claim 1 wherein the current density is a critical current density of above 3 mA·cm⁻².

3. The method of claim 1 wherein the lithium-based solid-state electrolyte is a laminate of a lithium lanthanum zirconium oxide (LLTZO) solid-state electrolyte and a reduced Graphene Oxide layer.

4. The method of claim 1 wherein the reduced Graphene Oxide interlayer is a flexible, porous carbon matrix.

5. The method of claim 1 wherein the reduced Graphene Oxide interlayer is a mixed ion-electron conductor.

6. The method of claim 1 wherein the reduced Graphene Oxide interlayer is a porous carbon matrix and a mixed ion-electron conductor.

7. The method of claim 1 wherein lithium dendrite, upon contact with the reduced Graphene Oxide layer, extends within the interlayer instead of continuing penetration through the lithium-based solid electrolyte.

8. The method of claim 1 wherein the reduced Graphene Oxide interlayer is between 10 μm and 30 μm in thickness.

9. The method of claim 1 wherein the reduced Graphene Oxide interlayer is about 20 μm in thickness.

10. The method of claim 1 wherein the lithium-based solid-state electrolyte is a laminate of an LLTZO solid-state electrolyte and a reduced Graphene Oxide layer,
wherein the reduced Graphene Oxide layer is between a first lithium-based solid-state electrolyte portion and a second lithium-based solid-state electrolyte portion.

11. The method of claim 1 wherein the lithium-based solid-state electrolyte is lithium lanthanum zirconium oxide solid-state electrolyte.

12. The method of claim 1 wherein the lithium-based solid-state electrolyte is tantalum-doped lithium lanthanum zirconium oxide solid state electrolyte.

13. The method of claim 1 wherein the lithium-based solid-state electrolyte is tantalum-doped lanthanum zirconium oxygen solid-state electrolyte having the formula Li_{6.4}La₃Zr_{1.7}Ta_{0.3}O₁₂.

14. A method of making an interlayered lithium-based solid electrolyte comprising
providing a lithium-based solid-state electrolyte with a reduced Graphene Oxide interlayer.

15. The method of claim 14 wherein the interlayered lithium-based solid-state electrolyte is a laminate of a lithium lanthanum zirconium oxide (LLTZO) solid-state electrolyte and a reduced Graphene Oxide layer.

16. The method of claim 14 wherein the reduced Graphene Oxide interlayer is a flexible, porous carbon matrix.

17. The method of claim 14 wherein the reduced Graphene Oxide interlayer is a mixed ion-electron conductor.

18. The method of claim 14 wherein the reduced Graphene Oxide interlayer is a porous carbon matrix and a mixed ion-electron conductor.

19. The method of claim 14 wherein the reduced Graphene Oxide interlayer is between 10 μm and 30 μm in thickness.

20. The method of claim 14 wherein the reduced Graphene Oxide interlayer is about 20 μm in thickness.

21. The method of claim 14 wherein the interlayered lithium-based solid-state electrolyte is a laminate of an LLTZO solid-state electrolyte and a reduced Graphene Oxide layer,
wherein the reduced Graphene Oxide layer is between a first lithium-based solid-state electrolyte portion and a second lithium-based solid-state electrolyte portion.

22. The method of claim 14 wherein the lithium-based solid-state electrolyte is lithium lanthanum zirconium oxide solid state electrolyte.

23. The method of claim 14 wherein the lithium-based solid-state electrolyte is tantalum-doped lithium lanthanum zirconium oxide solid-state electrolyte.

24. The method of claim 14 wherein the lithium-based solid-state electrolyte is tantalum-doped lanthanum zirconium oxygen solid-state electrolyte having the formula Li_{6.4}La₃Zr_{1.7}Ta_{0.3}O₁₂.

25. A lithium-based solid electrolyte having an interlayer of reduced Graphene Oxide.

26. The lithium-based solid electrolyte of claim 25 comprising a laminate of a lithium lanthanum zirconium oxide (LLTZO) solid-state electrolyte and a reduced Graphene Oxide layer.

27. The lithium-based solid electrolyte of claim 25 wherein the reduced Graphene Oxide interlayer is a flexible, porous carbon matrix.

28. The lithium-based solid electrolyte of claim 25 wherein the reduced Graphene Oxide interlayer is a mixed ion-electron conductor.

29. The lithium-based solid electrolyte of claim 25 wherein the reduced Graphene Oxide interlayer is a porous carbon matrix and a mixed ion-electron conductor.

30. The lithium-based solid electrolyte of claim 25 wherein the reduced Graphene Oxide interlayer is between 10 μm and 30 μm in thickness.

31. The lithium-based solid electrolyte of claim 25 wherein the reduced Graphene Oxide interlayer is about 20 μm in thickness.

32. The lithium-based solid electrolyte of claim 25,
wherein the reduced Graphene Oxide layer is between a first lithium-based solid-state electrolyte portion and a second lithium-based solid-state electrolyte portion.

33. The lithium-based solid electrolyte of claim 25 wherein the lithium-based solid-state electrolyte is lithium lanthanum zirconium oxide solid-state electrolyte.

34. The lithium-based solid electrolyte of claim 25 wherein the lithium-based solid-state electrolyte is tantalum-doped lithium lanthanum zirconium oxide solid-state electrolyte.

35. The lithium-based solid electrolyte of claim 25 wherein the lithium-based solid-state electrolyte is tantalum-doped lanthanum zirconium oxygen solid-state electrolyte having the formula Li_{6.4}La₃Zr_{1.7}Ta_{0.3}O₁₂.

36. A solid-state battery comprising the lithium-based solid electrolyte of claim 25.
